(19) United States
(12) Patent Application Publication
(10) Pub. No.: US 2023/0155141 A1
(43) Pub. Date: May 18, 2023

(54) Miniature Reserve Battery Arrays and Stand-Alone For Munitions and the Like

(71) Applicant: Omnitek Partners LLC, Ronkonkoma, NY (US)

(72) Inventors: Jahangir S Rastegar, Stony Brook, NY (US); Javier Alvare, Sandy, UT (US)

(73) Assignee: Omnitek Partners LLC, Ronkonkoma, NY (US)

(21) Appl. No.: 17/873,067

(22) Filed: Jul. 25, 2022

Related U.S. Application Data
(60) Provisional application No. 63/225,817, filed on Jul. 26, 2021.

(51) Int. Cl. H01M 6/32; H01M 50/155; H01M 50/193; H01M 50/184

(52) U.S. Cl. CPC H01M 6/32; H01M 50/155; H01M 50/193; H01M 50/184

(57) ABSTRACT

A reserve battery including: a housing has first and second compartments separated by a membrane, the first compartment has an anode and cathode and a separator positioned there between. The second compartment has an electrolyte for use with the anode and cathode to produce electrical power. The electrolyte being sealed in the second compartment relative to the first compartment at least by the membrane. Electrodes are connected to the anode and cathode and each has a portion on an outside of the housing. Where the second compartment has a cavity in which a wick material is arranged. The wick material is configured to pull the electrolyte into the second compartment from the first compartment by capillary action when the membrane changes from a sealed state in which the electrolyte is sealed within the second compartment to an unsealed state in which the electrolyte can flow into the first compartment.

### CROSS-REFERENCE TO RELATED APPLICATION

This application claims the benefit of priority to U.S. Provisional Application No. 63/225,817, filed on Jul. 26, 2021, the entire contents of which is incorporated here by reference.

### BACKGROUND

### 1. Field

The present disclosure relates generally to reserve power sources for munitions; and more particularly to liquid reserve batteries for use in gun-fired munitions, sub-munitions, mortars, rockets, missiles and the like that are easy to manufacture at relatively low cost, miniaturized, and sized to the available space.

### 2. Prior Art

Reserve batteries of the electrochemical type are well known in the art for a variety of uses where storage time before use is extremely long. Reserve batteries are in use in applications such as batteries for gun-fired munitions including guided and smart, mortars, fuzing mines, missiles, rockets, and many other military and commercial applications. The electrochemical reserve-type batteries can in general be divided into two different basic types.

The first type includes the so-called thermal batteries, which are to operate at high temperatures. Unlike liquid reserve batteries, in thermal batteries the electrolyte is already in the cells and therefore does not require a release and distribution mechanism such as spinning. The electrolyte is dry, solid and non-conductive, thereby leaving the battery in a non-operational and inert condition. These batteries incorporate pyrotechnic heat sources to melt the electrolyte just prior to use in order to make them electrically conductive and thereby making the battery active. The most common internal pyrotechnic is a blend of Fe and KClO₄. Thermal batteries utilize a molten salt to serve as the electrolyte upon activation. The electrolytes are usually mixtures of alkali-halide salts and are used with the Li(Si)/FeS₂ or Li(Si)/CoS₂ battery couples. Some batteries also employ anodes of Li(Al) in place of the Li(Si) anodes. Insulation and internal heat sinks are used to maintain the electrolyte in its molten and conductive condition during the time of use.

The second type includes the so-called liquid reserve batteries in which the electrodes are fully assembled, but the liquid electrolyte is held in reserve in a separate container until the batteries are activated on demand. In these types of batteries, since there is no electrochemical reaction in the inactive (reserve) state, the shelf life of the batteries is essentially unlimited. The battery is activated by transferring the electrolyte from its container to the battery electrode compartment (hereinafter referred to as the “battery cell”).

A typical liquid reserve battery is kept inert during storage by keeping the aqueous electrolyte separate in a glass or metal ampoule or in a separate compartment inside the battery case. The electrolyte compartment may also be separated from the electrode compartment by a membrane or the like. Prior to use, the battery is activated by breaking the ampoule or puncturing the membrane allowing the electrolyte to flood the electrodes. The breaking of the ampoule or the puncturing of the membrane is achieved either mechanically using certain mechanisms or by the high-G firing setback shock. In these batteries, the projectile spin or a wicking action of the separator is generally used to transport the electrolyte into the battery cells.

In recent years, there have been a number of advancements in reserve battery technologies. Among these advances are superhydrophobic nanostructured materials, bimodal lithium reserve battery, and ceramic fiber separator for thermal batteries. In one liquid reserve battery technology under development, “superhydrophobic nanostructured material” is used in a honeycomb structure to keep the electrolyte separated from the battery cell. “Electrowetting” is achieved by the application of a trigger voltage pulse. The electrolyte can then penetrate the honeycomb structure and come into contact with the electrodes, thereby making the cell electrochemically active.

The thermal reserve batteries and liquid reserve batteries are initiated as a result of the munitions firing setback acceleration using inertial igniters such as those disclosed in U.S. Pat. Nos. 7,437,995; 7,587,979; 7,587,980; 7,832,335 and 8,061,271 and U.S. patent application Ser. Nos. 12/774,324; 12/794,763; 12/835,709; 13/180,469; 13/207,280 and 61/551,405 (the full disclosure of each of which being incorporated herein by reference) or piezoelectric-based inertial igniters such as those disclosed in U.S. Pat. No. 8,024,469 and U.S. patent application Ser. Nos. 13/186,456 and 13/207,355 the full disclosure of each of which being incorporated herein by reference) or other similar inertial or electrical initiators. The piezoelectric-based inertial igniters, particularly those that can provide relatively long initiation delay, are highly advantageous since by delaying the initiation, the time period in which the battery is subjected to high acceleration/deceleration levels is reduced or even eliminated. The reserve battery may also be activated following launch when its power is needed, which may in certain cases be long after launch and even landing. The initiation devices to be used must also be capable to operate safely by differentiating all-fire and various no-fire events such as accidental drops and vibration and impact during transportation and loading and even nearby explosions. The task of differentiating all-fire conditions from no-fire conditions can be performed without the use of external acceleration sensors and the like, and/or the use of external power sources.

The currently available liquid reserve batteries of all types and configurations and those that are known to be under development suffer from several basic shortcomings for munitions applications.
1. The main shortcoming is their very poor performance at low temperatures, usually below −25 deg. F. and for becoming almost non-functional at lower temperatures. In most munition applications, however, the batteries are required to be operational at significantly below −40 deg. C. and sometimes as low as −54 deg. C.
2. The second shortcoming of liquid reserve batteries is their relatively slow rise time, particularly at low temperatures.
3. In addition, the use of glass ampule for electrolyte storage and its general has presented a wide range of manufacturing and safety problems. When bellow type electrolyte storage devices are used, such electrolyte storage devices only eject a relatively small fraction of their electrolyte content into the battery core and occupy a relatively large volume, thereby resulting in a significantly larger battery size.

In addition, in many applications, small reserve batteries, sometimes mm-scale or even smaller reserve batteries are needed for powering munitions electronics. Fabricating thermal batteries in sub-mm and even mm-scale is not practical due to thermal issues. The smallest liquid reserve battery fabricated to date is 0.25 inch in diameter. The only micro- and mm-scale battery concept developed to date uses hydrophobic membrane to store the battery electrolyte and release it by the application of an electric field. The concept, however, has the following basic shortcomings, particularly for munitions applications:
1. The superhydrophobic membranes contain organic perfluorinated (e.g., PTFE) type coatings with poor shelf-life performance. Such membranes would not meet the military 20 years shelf-life requirement.
2. Battery activation requires onboard electrical power for electrowetting, which demands low current but relatively high voltages (electric field).
3. The use of high surface tension electrolytes can present difficulties in wetting the porous cathode electrodes, thereby resulting in relatively long activation times and loss of discharge capacity.
4. The batteries require gravity or spin to force the electrolyte to flow into the battery cell to activate the battery and stay in the battery core to activate and keep the battery in its activated state.

The small and mm-scale or even micro-scale reserve batteries have many munitions and commercial applications, particularly for emergency devices and systems. The small reserve batteries also present several advantages over larger reserve batteries, such as the fact that they can be distributed over the various components of the munition or the system in which they are used and be activated on demand. For example, such micro- and mm-scale reserve batteries may even be fabricated on a chip or can be mounted on circuit boards or the like and be directly integrated into electronic devices, sensors, and other power consuming components of munitions. Other beneficial characteristics of such small reserve batteries include the following:
1. The micro-scale and mm-scale reserve batteries can be fabricated in arrays of individually activated cells by the host system controls to provide the desired voltage and power to intended components of the munition.
2. The reserve batteries can be configured to be hardened for a wide range of munitions applications. When fabricated in small sizes, such as in micro-scale or mm-scale, due to their small size, they can be configured to withstand very high firing setback and target impact accelerations and spin accelerations and rates.
3. The micro- and mm-scale reserve batteries may be fabricated on almost any substrate, including metallic substrates. The novel micro- and mm-scale reserve batteries may therefore be integrated into the structure of various components of the munition or other systems, thereby being distributed inside the munitions available space and close to the components being powered on demand.
4. Due to their small size, micro-scale and mm-scale reserve batteries can be configured to provide very rapid rise time unlike larger liquid reserve and thermal reserve batteries.
5. The micro-scale and mm-scale reserve batteries may be configured to be activated by setback acceleration upon munitions firing for initial powering of the munition system electronics. The need for other onboard sources of electrical energy is thereby eliminated.
6. The provision of setback acceleration activated micro-scale and mm-scale reserve batteries provides the means of powering munitions electronics very rapidly, potentially even before barrel exit.

The mm-scale reserve batteries can be readily scalable to significantly larger sizes, such as up to even several centimeters, and manufacturable without a significant amount of tooling and process modifications at lower costs.

The mm-scale reserve batteries can be capable being configured and fabricated in almost any cross-sectional geometries to occupy the available space in munitions or other devices and systems to minimize the spaces that are commonly occupied by reserve batteries.

FIG. 1 illustrates the cross-sectional view of a micro-scale and mm-scale reserve battery unit 10 of an array of such batteries of the prior art in its pre-activation and post activation states as disclosed in the U.S. Pat. Nos. 7,618,746 and 8,021,773. The battery array prototype is fabricated on a silicon wafer. In FIG. 1, a single battery unit of this liquid reserve battery type is shown with the housing 16 that is provided in the battery substrate 14. The battery housing is sealed by a cap 15. In this technology, “superhydrophobic nanostructured material” is used in a honeycomb structure as membrane 12, to keep the electrolyte provided in the compartment 11 separated from the battery cell 17. The membrane samples are produced in silicon in a honeycomb structure, and are then coated with the special hydrophobic coating, such as vapor deposited fluorocarbons to dip coatings of fluoropolymers (Teflon© and CYTOP©), to render them superhydrophobic.

“Electrowetting” is then achieved by the application of a trigger voltage pulse to the membrane. The electrolyte can then penetrate the honeycomb structure and come into contact with the electrodes 13, thereby making the cell electrochemically active. In this activated state of the battery cell, the electrolyte is indicated by the numeral 18.

The prior art liquid reserve battery configuration of FIG. 1, as was previously indicated, has many shortcomings. In addition, the flow of the electrolyte into the battery core is greatly inhibited due to the closed volume of the electrolyte compartment and the surface and the vacuum that is generated as the electrolyte would tend to flow into the battery core, particularly if the electrolyte as any significant surface tension, which is the case in higher performance electrolytes. In addition, the presence of the honeycomb membrane prevents the use of wicks to allow the electrolyte to be drawn into the battery core by capillary action.

### SUMMARY

A need therefore exists for novel micro-scale and mm-scale liquid reserve batteries that can be manufactured in arrays of individually activated cells by the host system controls to provide the desired voltage and power to intended components on demand.

A need also exists for novel mm-scale reserve battery configurations that are readily scalable to significantly larger sizes, such as up to even several centimeters, and manufacturable without a significant amount of tooling and process modifications at lower costs.

A need also exists for novel mm-scale reserve batteries that are capable of being configured and fabricated in almost any cross-sectional geometries to occupy the available space in munitions or other devices and systems to minimize the spaces that are commonly occupied by reserve batteries.

A need also exists for novel micro-scale and mm-scale reserve battery configurations that can be hardened to withstand very high setback and target impact accelerations that may be as high as 100,000 Gs or more and high spin accelerations and spin rates that exceed 1000 Hz.

A need also exists for novel micro-scale and mm-scale reserve battery configurations that can be fabricated on almost any substrate, including metallic substrates. The novel micro- and mm-scale reserve batteries may therefore be integrated into the structure of various components of munitions or other devices and systems, thereby being capable of being distributed inside the available spaces in munitions or other systems and close to the components being powered on demand.

A need also exists for novel small size, micro-scale and mm-scale reserve batteries that can be configured to provide very rapid rise time, such as less than 10 milliseconds, unlike larger liquid reserve and thermal reserve batteries.

A need also exists for novel micro-scale and mm-scale reserve batteries that can be configured to be activated by setback acceleration upon munitions firing or upon target impact for initial powering of the munition system electronics. Such inertially activated reserve batteries would eliminate the need for other onboard sources of electrical energy. The initiation devices to be used must also be capable to operate safely by differentiating all-fire and various no-fire events such as accidental drops and vibration and impact during transportation and loading and even nearby explosions. The task of differentiating all-fire conditions from no-fire conditions can be performed without the use of external acceleration sensors and the like, and/or the use of external power sources. The inertial initiation mechanism can be integral to the structure of the reserve batteries. The novel micro-scale and mm-scale reserve batteries may also be activated following launch when its power is needed, which may in certain cases be long after launch and even landing.

A need also exits for novel micro-scale and mm-scale reserve batteries that can effectively operate with good performance at low temperatures, particularly at temperatures that may be as low as −54 deg. C.

An objective is to provide new liquid reserve batteries (power sources) that can be fabricated in micro-scale and/or mm-scale and be scaled to significantly larger, multi-centimeter scale. Such liquid reserve batteries can be used to power munitions, such as small and medium caliber munitions, sub-munitions, and the like. Such liquid reserve batteries can be used to power many commercial devices, such as emergency sensors, transmitters, alarm systems, and the like.

Another objective is to provide new types of liquid reserve batteries and methods of their configuration and construction such that they fabricated in micro-scale and mm-scale sizes as well as be readily scalable to significantly larger sizes, such as to even several centimeters, and manufacturable without a significant amount of tooling and process modifications at relatively low cost.

Another objective is to provide new types of liquid reserve batteries and methods of their configuration and construction such that they fabricated in arrays of micro-scale and mm-scale batteries that can be individually activated by the host controls on demand.

Another objective is to provide new types of liquid reserve batteries and methods of their configuration and construction with almost any cross-sectional geometries to occupy the available space in munitions or other devices and systems to minimize the spaces that are commonly occupied by reserve batteries.

Another objective is to provide new types of liquid reserve batteries and methods of their configuration and construction such that they can be hardened to withstand very high setback and target impact accelerations that may be as high as 100,000 Gs or more and high spin accelerations and spin rates that exceed 1000 Hz.

In particular, there is a need for relatively small reserve power sources for munitions, particularly for smaller caliber munitions, that can withstand very high firing accelerations; have very long shelf life, such as beyond 20 years; and that can be in munitions with very high spin acceleration and rates.

Another objective is to provide new types of liquid reserve batteries and methods of their configuration and construction for fabrication on various substrates, such as silicon, metallic and non-conductive substrates. The micro- and mm-scale and larger size (even several centimeter size) reserve batteries may therefore be integrated into the structure of various components of munitions or other devices and systems, thereby being capable of being distributed inside the available spaces in munitions or other systems and close to the components being powered on demand.

Another objective is to provide new types of liquid reserve batteries and methods of their configuration and construction so that they can provide very rapid rise time upon activation, such as even less than 10 milliseconds, unlike larger liquid reserve and thermal reserve batteries.

Another objective is to provide new types of liquid reserve batteries and methods of their configuration and construction that can be activated by setback acceleration upon munitions firing or upon target impact for initial powering of the munition system electronics to eliminate the need for other onboard sources of electrical energy. The initiation devices to be used must also be capable to operate safely by differentiating all-fire and various no-fire events such as accidental drops and vibration and impact during transportation and loading and even nearby explosions. The inertial initiation mechanism can be integral to the structure of the reserve batteries.

Another objective is to provide new types of liquid reserve batteries and methods of their configuration and construction such that they could be activated and operated with good performance at low temperatures, particularly at temperatures that may be as low as −54 deg. C.

In one disclosed micro-scale and/or mm-scale and/or significantly larger (centimeter scale) reserve batteries, the batteries can generally be classified as liquid reserve battery configuration type, in which the electrolyte is stored in a separate compartment and is separated from the battery core by a membrane. An electric current is then used to rupture the membrane and allow the electrolyte to be pulled into the battery core and activate the battery on demand. In this configuration, the battery is pulled into the battery core by the provided wick material via capillary action. As a result, unlike previously mentioned current micro-scale concept, the reserve battery does not rely on gravity or spin to eject the electrolyte into the battery core.

To ensure safety and reliability, the micro-scale and/or mm-scale and/or significantly larger (centimeter scale) reserve batteries are configured to withstand and not initiate during acceleration events which may occur during manufacture, assembly, handling, transport, accidental drops, etc.

### BRIEF DESCRIPTION OF THE DRAWINGS

These and other features, aspects, and advantages of the apparatus of the present embodiments will become better understood with regard to the following description, appended claims, and accompanying drawings where:

FIG. 1 illustrates a sectional schematic of a micro-scale and mm-scale reserve battery unit of an array of such batteries of prior art in its pre-activation and post activation states.

FIG. 2 illustrates the schematic basic configuration of an array of micro-scale or mm-scale or larger scale batteries.

FIG. 3 illustrates the schematic of one of the micro-scale or mm-scale or larger scale battery units of the battery array of FIG. 2.

FIG. 4 illustrates the cross-sectional view of a single battery unit of FIG. 3 of the first embodiment in its pre-activation (reserve) state.

FIG. 5 illustrates the cross-sectional view of a single battery unit of FIG. 3 of the first embodiment in its activated state.

FIG. 6 illustrates the schematic of one solid membrane embodiment for separating the electrolyte storage compartment from the battery unit core compartment.

FIG. 7 illustrates the schematic of another solid membrane embodiment for separating the electrolyte storage compartment from the battery unit core compartment.

FIG. 8 illustrates the cross-sectional view of a single battery unit of FIG. 3 of the second embodiment in its pre-activation (reserve) state and configured for inertial activation by firing setback acceleration.

FIG. 9 illustrates the cross-sectional view of a single battery unit of FIG. 3 of the second embodiment in its post activation (reserve) state and configured for inertial activation by firing setback acceleration.

FIG. 10 illustrates the cross-sectional view of an alternative single battery unit of the embodiment of FIG. 9 in its pre-activation (reserve) state as configured for inertial activation by firing setback acceleration.

FIG. 11 illustrates the cross-sectional view of the alternative single battery unit of the embodiment of FIG. 9 in its activated state as configured for inertial activation by firing setback acceleration.

FIG. 12 illustrates the cross-sectional view of a single reserve battery unit of FIG. 3 of the third embodiment in its pre-activation (reserve) state and configured for inertial activation by firing setback acceleration.

FIG. 13 illustrates the cross-sectional view of a single reserve battery unit of FIG. 3 of the third embodiment in its post activation (reserve) state and configured for inertial activation by firing setback acceleration.

FIG. 14 illustrates the blow-up view “A” of the cross-sectional view of the reserve battery unit of embodiment of FIG. 12.

FIG. 15 illustrates the cross-sectional view of a stand-alone reserve battery unit embodiment in its pre-activation (reserve) state and configured for inertial activation by firing setback or impact acceleration.

FIG. 16 illustrates the cross-sectional view of the stand-alone reserve battery unit embodiment of FIG. 15 in its post activation state.

FIG. 17 illustrates the cross-sectional view of another stand-alone reserve battery unit embodiment in its pre-activation (reserve) state and configured for inertial activation by firing setback or impact acceleration.

FIG. 18 illustrates the cross-sectional view of the stand-alone reserve battery unit embodiment of FIG. 17 in its post activation state.

FIG. 19 illustrates the cross-sectional view of the first manually activated stand-alone reserve battery unit embodiment in its pre-activation (reserve) state.

FIG. 20 illustrates the cross-sectional view of the manually activated stand-alone reserve battery embodiment of FIG. 19 in its post activation state.

FIG. 21 illustrates the cross-sectional view of the modified version of the manually activated stand-alone reserve battery embodiment of FIG. 19 configured for inertial activation in its pre-activation (reserve) state.

FIG. 22 illustrates the cross-sectional view of the modified stand-alone reserve battery embodiment of FIG. 21 in its post activation state.

FIG. 23 illustrates the cross-sectional view of another stand-alone reserve battery embodiment in its pre-activation (reserve) state and configured for inertial activation by firing setback or impact acceleration.

FIG. 24 illustrates the cross-sectional view of the stand-alone reserve battery unit embodiment of FIG. 23 in its post activation state.

FIG. 25 illustrates the cross-sectional view of a modified version of the stand-alone reserve battery embodiment of FIG. 23 in its pre-activation (reserve) state and configured with added charge collector pressure spring member.

### DETAILED DESCRIPTION

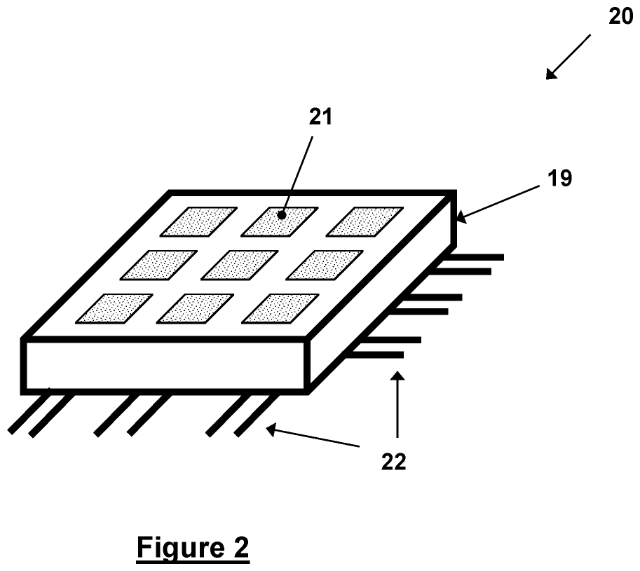

A configuration of an array of micro-scale or mm-scale and even larger scale batteries is shown in the schematic of FIG. 2 and indicated by the numeral 20 and is hereinafter referred to as the “battery array”. The array of battery units is generally fabricated in a substrate, which may be a silicon wafer or almost any other material that may have to be provided with an appropriate coating to serve as the housing for the battery unit. The battery array may also be covered by a thin and relatively flexible and extensible layer (such as silicon rubber) to provide for sealing from an outside environment as to assist in battery activation as described later in this disclosure.

The “battery array” 20 of FIG. 2 may contain any number of “battery units” 21, which may be equal sizes or different sizes and with different cross-sectional geometry as viewed in planes parallel to its top surface (e.g., with square, rectangular, circular, or oval cross-sections). The battery units 21 can have constant cross-sections along their height, i.e., in the depth of their cavities inside the substrate 19. The battery units may also be distributed over the structures of various devices to provide a distributed power system to provide power on demand and avoid wiring over relatively long distances.

In the schematic of FIG. 2, the terminals 22 of the battery units 21 are shown to exit from the side of the array substrate 19, but it may also be configured to exit from any desired direction, including from the bottom surface of the substrate 19, for example, having surface electrodes for direct mounting to a printer circuit board.

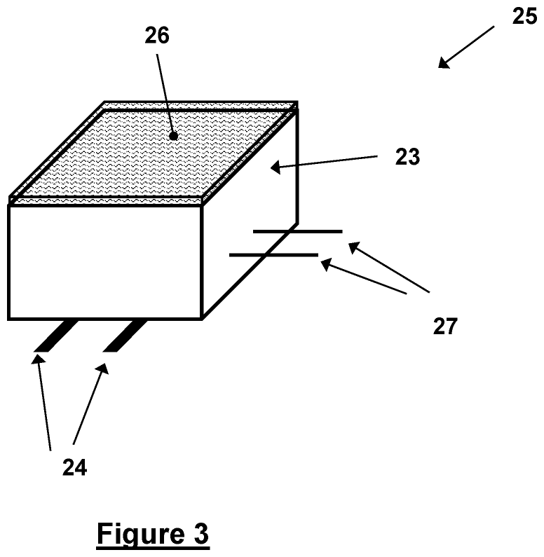

FIG. 3 illustrates the schematic of one of the micro-scale or mm-scale or larger scale battery units 21 of the battery array of FIG. 2 and is indicated by the numeral 25. The battery unit 25 is housed in a corresponding cavity provided in the battery array 20, FIG. 2. In the schematic of FIG. 3, the side walls 23 and the bottom side of the cavity are then part of the substrate 19 of the battery array 20, FIG. 2. The battery top cover 26 (not shown in FIG. 2 for the sake of clarity) is then provided to seal the battery unit compartments. A battery unit 25 may also be provided with lead wires 27 for battery activation as described later in this disclosure. The battery array can be fabricated on almost any component structure as well as on-the-chip to accommodate the battery units as later described.

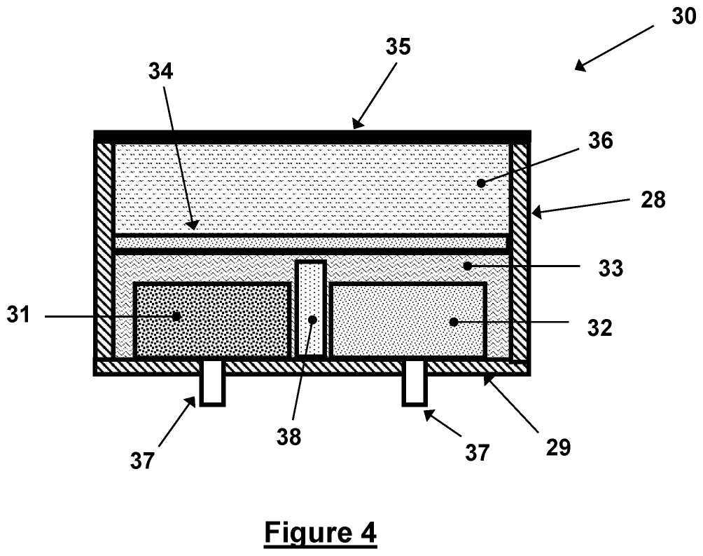

The cross-sectional view of a single battery unit of FIG. 3 of the first embodiment is shown in the schematic of FIG. 4 and is indicated by the numeral 30. In the schematic of FIG. 4, the side walls 28 and the bottom side 29 of the battery unit cavity are part of the substrate 19 of the battery array 20, FIG. 2. As can be seen in FIG. 4, the inside volume of the battery unit embodiment 30 is divided into a lower compartment 33 and an upper compartment 36 by a relatively solid separator membrane 34. The lower compartment 33 constitutes the battery core, within which the cathode 31 and anode 32 components of the battery and their separator 38 are positioned. The void in the cavity 33 can be filled with a wick material to pull the electrolyte into the battery compartment 33 by capillary action upon battery activation as described later.

In the schematic of FIG. 4, the battery terminals 37 (their surrounding electrical insulation layer not shown) are shown to exit from the bottom surface 29 of the battery unit. The compartment 36 of the battery unit embodiment 30 is used to store the battery electrolyte while the battery unit is in its pre-activation (reserve) state. The battery top cover 35 (26 in FIG. 3) can be a relatively thin flexible and extensible (for example, silicon rubber or the like) layer.

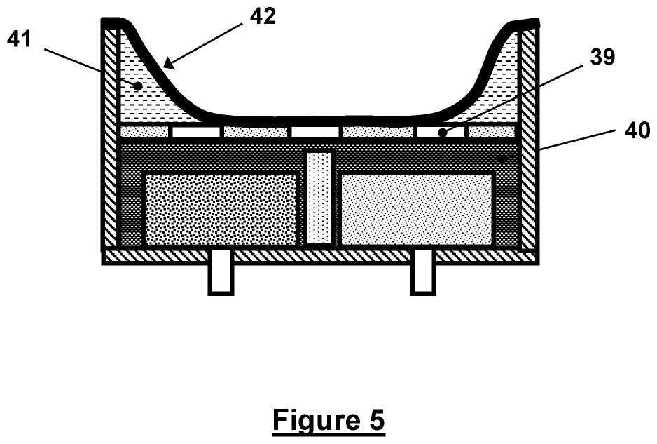

Battery unit embodiment 30 is then activated by partial removal/rupture of the membrane 34 barrier and allowing the electrolyte from the compartment 36 to flow into the battery core compartment 33 as later described. In FIG. 5 the battery unit embodiment 30 is shown in its activated state.

As can be seen in FIG. 4, prior to the battery activation, the electrolyte is stored between the membrane 34 and the battery top thin flexible and extensible (silicon rubber or the like) layer 35. Then following partial rupture of the membrane 34 as is described later and indicated with the openings 39 in FIG. 5, the liquid electrolyte is released and is pulled into the battery core by the capillary action of the provided wick material in the compartment 33, FIG. 4, filling the battery core around the cathode 31 and anode 32, respectively, as shown in FIG. 5. Hereinafter, the rupture, breaking, piercing, melting or any another means for changing the membrane from a sealed state in which the electrolyte is sealed in the compartment having the electrolyte (36 in FIG. 4) to an unsealed state in which the electrolyte can flow into the compartment having the anode and cathode (33 in FIG. 5) is collectively referred to as the membrane being “broken.”

As the liquid electrolyte is pulled into the battery core cavity by the indicated capillary action of the provided wick material, the top flexible and extensible layer 42 (35 in FIG. 4) would expand to fill the vacated volume as shown in FIG. 5, allowing most of the electrolyte to be moved into the battery core, leaving a negligible amount of electrolyte (indicated by the numeral 41 in FIG. 5) in the spaces left between the conforming flexible and extensible layer 42 and the remnants of the membrane 34 and the walls 28 (FIG. 4) seen in FIG. 5.

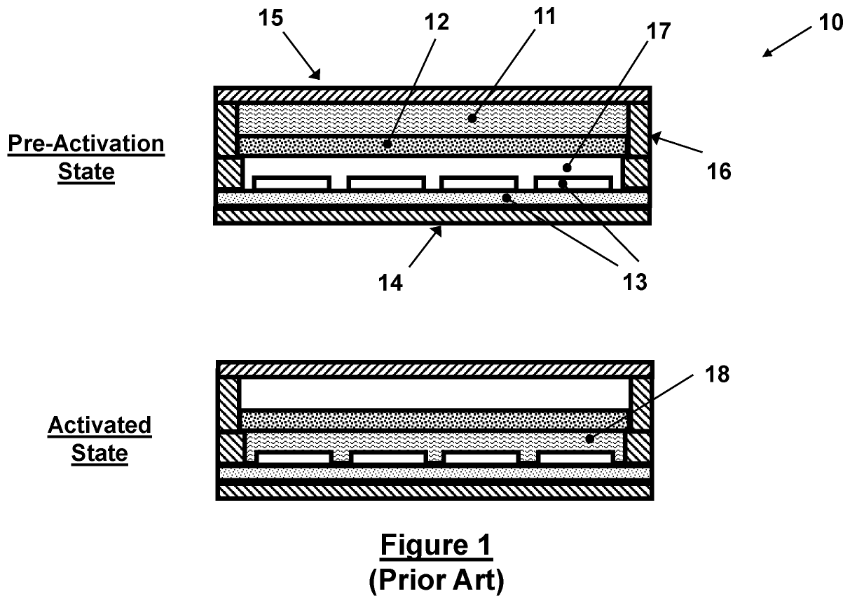

It is appreciated by those skilled in the art that the provision of the wick material in the battery core compartment 33 and the indicated use of capillary action to pull the liquid electrolyte into the battery core to activate the battery eliminates the need for gravity or other pressurization method to force the electrolyte into the battery core as is the case for the prior art embodiment of FIG. 1. In addition, the provision of the thin flexible and extensible layer (35 in FIG. 4 and in its deformed state 42 in FIG. 5) overcomes the generated vacuum in the electrolyte storage compartment as is the case in the prior art embodiment of FIG. 1.

The battery units 30 shown in the cross-sectional view of FIG. 4 may be configured and fabricated and operate with several types of membranes 34, including the ones described below. All provided membrane options are configured to overcome the previously indicated shortcomings of hydrophobic membranes of different types used in the battery units of prior art of FIG. 1.

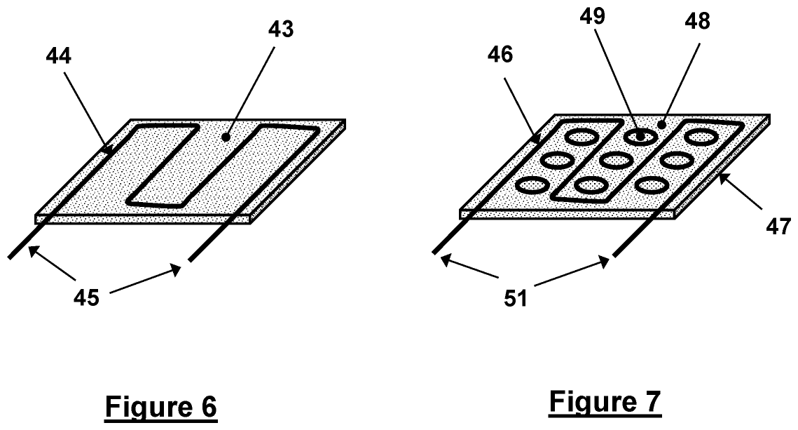

In one embodiment, a solid separator membrane 43, FIG. 6, made of a low melting temperature material, such as a paraffinic wax or similar material, is used to separate the electrolyte compartment 36 from the battery unit active components compartment 33 in the pre-activation (reserve) state as shown in the cross-sectional view FIG. 4. The solid separator membrane 43 is provided with an embedded heating element 44 (heating filament) as shown in FIG. 6, which is powered via the terminals 45 (27 in FIG. 3), to partially melt the wax to allow the stored electrolyte to flow into the battery unit compartment 33. The porous wick material would also assist in drawing the electrolyte into the battery core by the capillary action. In practice, the low melting temperature material (e.g., paraffinic wax or other similar material) may be directly deposited over the indicated wick material.

It is appreciated that the embedded heating element 44 is configured to act like bridge wires used in electrical initiators and could also be coated with some minute particles (not shown) of pyrotechnic material to facilitate and expedite partial melting process of the paraffinic wax or similar material layer 43.

Alternatively, to facilitate deposition of the filament wire using semiconductor foundry processes or the like, the heating filament 46 may be deposited over a solid layer 47, for example a thin ceramic layer with a series of openings 49 which are then covered by the sealing layer of solid paraffin wax or the like 48 as shown in FIG. 7. The filament wire 46 may be similarly coated with some minute particles of pyrotechnic material to facilitate and expedite partial melting process of the wax layer. The terminals 51 (27 in FIG. 3) are used to power the filament wire 46.

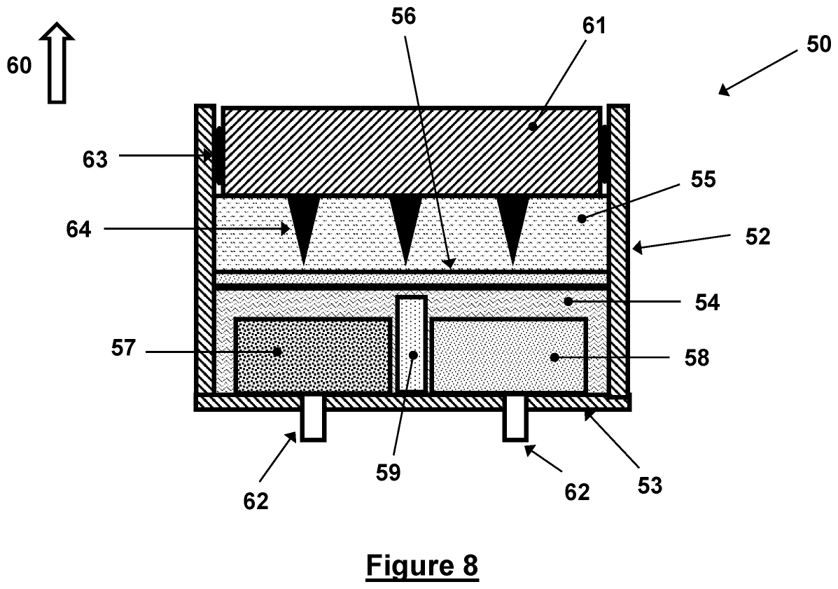

The cross-sectional view of a single battery unit of FIG. 3 of the second embodiment is shown in the schematic of FIG. 8 and is indicated by the numeral 50. The battery unit 50 is shown in its pre-activation state in FIG. 8. In the schematic of FIG. 8, the side walls 52 and the bottom side 53 of the battery unit cavity are part of the substrate 19 of the battery array 20, FIG. 2. As can be seen in FIG. 8, the inside volume of the battery unit embodiment 50 is divided into a lower compartment 54 and an upper compartment 55 by a relatively solid separator membrane 56. The lower compartment 54 constitutes the battery core, within which the cathode 57 and anode 58 components of the battery and their separator 59 are positioned. The void in the cavity 54 can be filled with a wick material to pull the electrolyte filling the upper compartment 55 into the battery compartment 54 by capillary action upon battery activation as described later. In the schematic of FIG. 8 the battery terminals 62 (their surrounding electrical insulation layer not shown) are shown to exit from the bottom surface 53 of the battery unit.

The battery units 50 cavities, like the embodiment 30 of FIG. 4, may still be configured in an array form on the array substrates as shown in the schematics of FIG. 2. The substrate may be a silicon wafer or almost any other material that may have to be provided with an appropriate coating to serve as the housing of a battery unit.

As indicated, the solid separator membrane 56, which may be a thin ceramic or the like material membrane, is used to separate the electrolyte filling the compartment 55 from the battery active compartment 54 as shown in the cross-sectional view of the battery unit 50 in its pre-activation (reserve) state in FIG. 8.

As can be seen in FIG. 8, the battery unit 50 is provided with an inertial mass 61, which is provided with peripheral seal 63 to seal the electrolyte within the compartment 55. The inertial mass 61 is otherwise free to be forced to translate downward as seen in the view of FIG. 8.

As can be seen in FIG. 8, the battery electrolyte fills the volume provided between the solid membrane 56 and the sealed inertial mass 61. In practice, the seal is deposited over the entire periphery of the inertial mass. The inertial mass 61 is also provided with one or more membrane cutter (puncturing) members 64, depending on the size of the reserve battery unit 50.

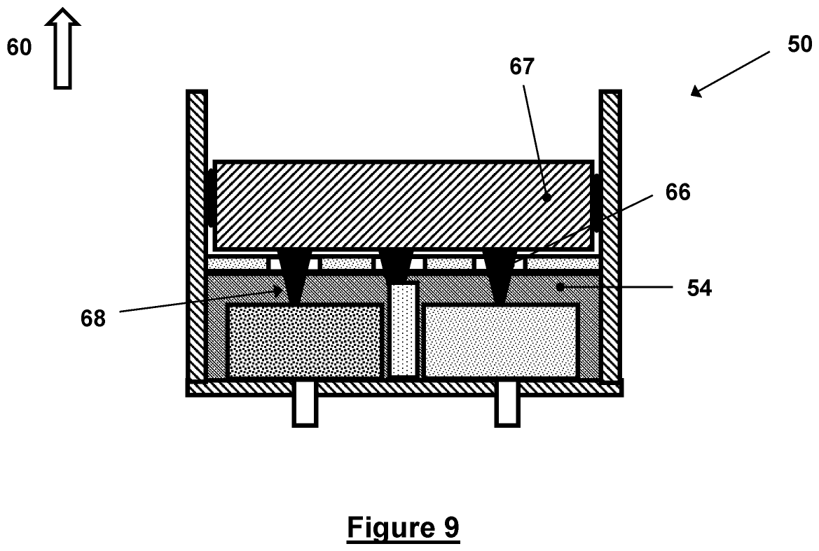

Now when the reserve battery unit 50 is subjected to firing setback acceleration in the direction of the arrow 60 as seen in FIG. 8, the inertial force acting on the inertial mass 61 is configured to apply a downward force on the inertial mass 61 and begin to displace it downward, causing the “membrane cutters” 64 to puncture the membrane 56 (punctured opening shown schematically openings indicated by numeral 66 in FIG. 9) and force the electrolyte to flow into the battery core, thereby activating the battery unit 50 as shown in the battery unit activated state of FIG. 9. In the activated state of the battery unit shown in FIG. 9, the inertial mass is indicated by the numeral 67 (61 in pre-activated state of FIG. 8) and its “membrane cutters” by the numeral 68. It is appreciated that the cathode 57 and anode 58 are shaped to allow the membrane cutters 68 to clear the two components while breaking through the membrane 56, FIG. 8.

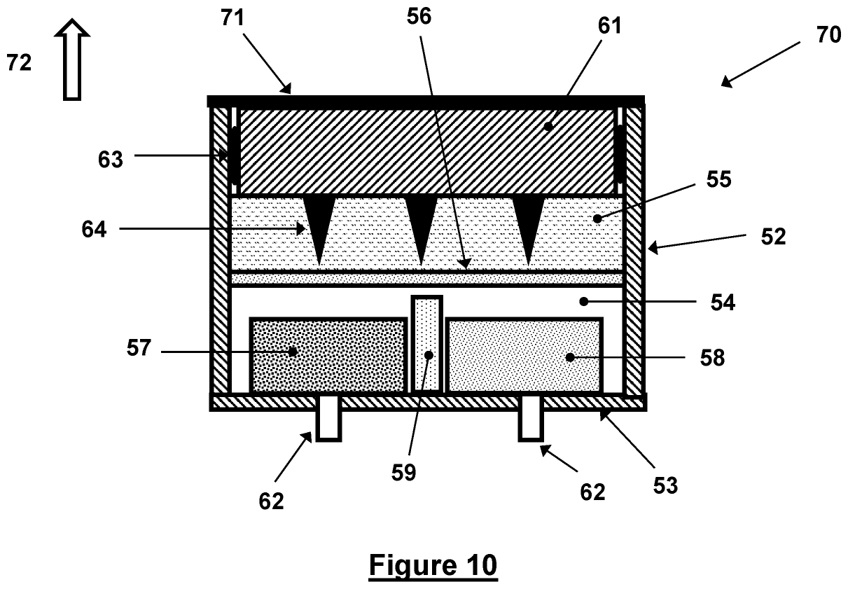

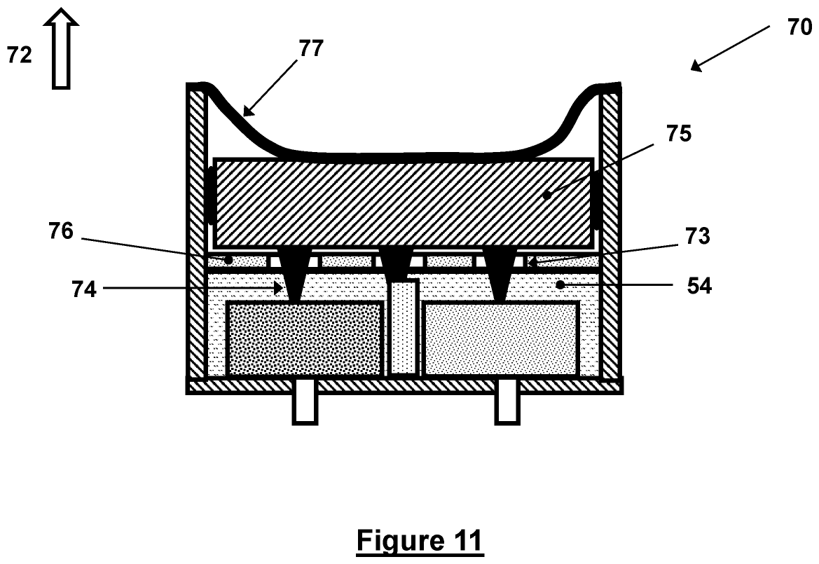

An alternative configuration of the inertially activated reserve battery unit 50 of FIG. 8, which would facilitate its mass manufacture is shown in its pre-activated and activated states in FIGS. 10 and 11 and indicated as embodiment 70. The reserve battery unit embodiment 70 is identical to the battery unit embodiment 50 of FIG. 8, except for the added flexible and extensible top sealing layer 71 (usually a deposited silicon rubber or the like layer), which is used to seal the battery interior from outside environment, and that the peripheral seal 63 is no longer necessary, but may in practice be provided for the purpose of stability during the process of manufacturing the battery units and vibration and accidental drop resistance. The reserve battery units 70 are, however, provided with a flexible and extensible top sealing layer 71 (such as deposited silicon rubber or the like), which in addition of being capable of being “stretched” to conform to the geometry described below, is also intended to provide for the sealing action before and after battery activation to protect the battery unit interior from environmental elements.

Now when the reserve battery unit 70 is subjected to firing setback acceleration in the direction of the arrow 72 as seen in FIG. 10, the inertial force acting on the inertial mass 61 is configured to apply a downward force on the inertial mass 61 and begin to displace it downward, causing the “membrane cutters” 64 (74 in FIG. 11) to puncture the membrane 56 (punctured opening shown schematically openings indicated by numeral 73 in FIG. 11) and force the electrolyte to flow into the battery core compartment 54, thereby activating the reserve battery unit 70 as shown in the battery unit activated state of FIG. 11. In the battery unit 70 activated state of FIG. 11, the inertial mass is indicated by the numeral 75 and its “membrane cutters” by the numeral 76. It is appreciated that the cathode 57 and anode 58 are shaped to allow the membrane cutters 74 to clear the two components while breaking through the membrane 56, FIG. 10.

It is appreciated that as the liquid electrolyte is pushed into the battery core cavity 54 by the inertial mass 75 downward displacement, the top flexible and extensible layer 71, FIG. 10, would expand to fill most of the vacated volume as shown in FIG. 11 and indicated by the numeral 77.

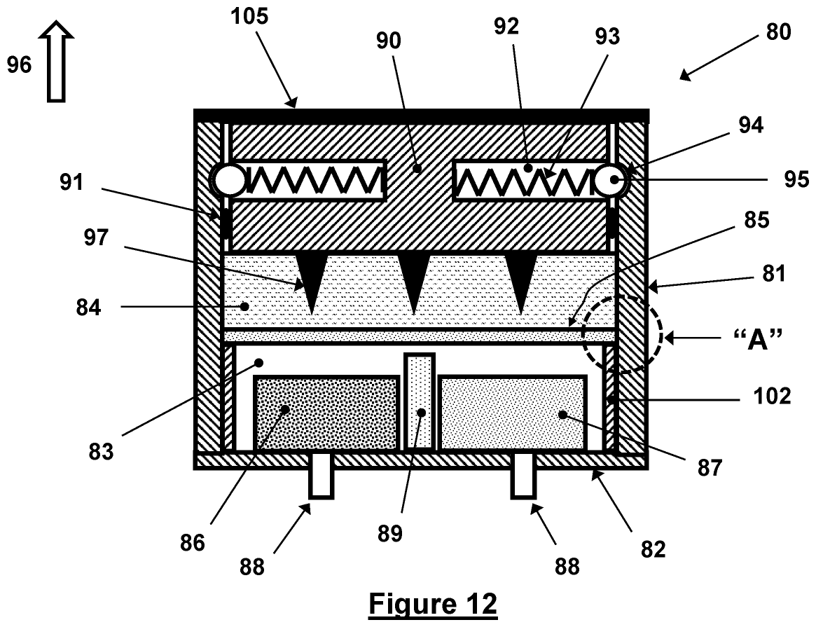

The cross-sectional view of a single battery unit of FIG. 3 of the third embodiment is shown in the schematic of FIG. 12 and is indicated by the numeral 80. The battery unit 80 is shown in its pre-activation state in FIG. 12. In the schematic of FIG. 12, the side walls 81 and the bottom side 82 of the battery unit cavity are part of the substrate 19 of the battery array 20, FIG. 2. As can be seen in FIG. 12, the inside volume of the battery unit embodiment 80 is divided into a lower compartment 83 and an upper compartment 84 by a relatively solid separator membrane 85. The lower compartment 83 comprises the battery core, within which the cathode 86 and anode 87 components of the battery and their separator 89 are positioned. The void in the cavity 83 may be filled with a wick material to pull the electrolyte filling the upper compartment 84 into the battery compartment 83 by capillary action upon battery activation as described later. In the schematic of FIG. 12 the battery terminals (their surrounding electrical insulation layer not shown) 88 are shown to exit from the bottom surface 82 of the battery unit.

The battery units 80 cavities, like the embodiment 30 of FIG. 4, may still be configured in an array form on the array substrates as shown in the schematics of FIG. 2. The substrate may be a silicon wafer or almost any other material that may have to be provided with an appropriate coating to serve as the housing of a battery unit.

As indicated, the solid separator membrane 85, which may be a thin ceramic or the like material membrane, is used to separate the electrolyte filling the compartment 84 from the battery active compartment 83 as shown in the cross-sectional view of the battery unit 80 in its pre-activation (reserve) state in FIG. 12.

As can be seen in FIG. 12, the battery unit 80 is provided with an inertial mass 90, which is provided with peripheral seal 91 to seal the electrolyte within the compartment 84. The inertial mass 80 is provided with several (such as three or four) cylindrical holes 92, which are symmetrically positioned around the inertial mass 80 as shown in FIG. 12. In each cylindrical hole, a preloaded compressive spring 93 is provided, which is used to press the ball 95 into the provided dimple 94 formed on an inside the side wall 81 as shown in FIG. 12. The spring rate of the compressive springs 93 and their preloading level are selected such that the inertial mass 90 would be prevented to displace down enough to release the balls 95 from the dimples 94, unless the battery unit 80 is subjected to a high enough acceleration level and for long enough duration in the direction of the arrow 96 (corresponding to the munitions no-fire condition using the battery unit). Once the inertial mass 90 has displaced down enough to free the balls 95 out of the dimples 94, the inertial mass is then free to be forced to translate downward as seen in the view of FIG. 12, with minimal frictional resistance from the balls 95 and the seal 91.

As can be seen in FIG. 12, the battery electrolyte fills the volume provided between the solid membrane 85 and the sealed inertial mass 90. In practice, the seal is deposited over the entire periphery of the inertial mass. The inertial mass 90 is also provided with one or more membrane cutter (puncturing) members 97, depending on the size of the reserve battery unit 80.

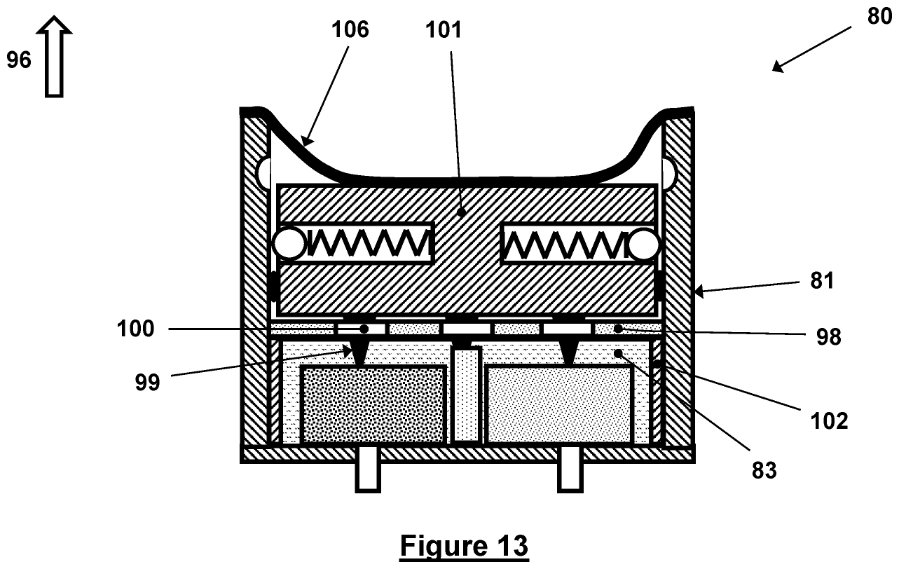

Now when the reserve battery unit 80 is subjected to firing setback acceleration in the direction of the arrow 96 as seen in FIG. 12, the inertial force acting on the inertial mass 90 is configured to apply a downward force on the inertial mass 90, which if it is larger than the retaining force provided by the balls 94 in the dimples 95 due to the preloading force of the compressive springs 93, then the inertial mass 90 would begin displace downward. Now, if the acceleration in the direction of the arrow 96 ceases before the balls 94 have fully disengaged the dimples 95, then the preloaded compressive springs would force the balls 94 back into the dimples 95, thereby returning the inertial mass 90 to its pre-acceleration state shown in FIG. 12. This could, for example, happen due to accidental drop of the device in which the reserve battery unit 80 is positioned or due to transportation vibration or other accidental events due to which the reserve battery unit 80 is not to activate (no-fire conditions in munitions). However, if the acceleration in the direction of the arrow 96 has high enough magnitude and long enough duration (which is considered to be an “all-fire condition” in munitions), then the inertial mass 90 continues to displace downward, causing the “membrane cutters” 99 (97 in FIG. 12) to puncture the membrane 98 (85 in FIG. 12). In FIG. 13, the punctured openings are shown schematically and indicated by numeral 100. The electrolyte stored in the compartment 84 (FIG. 12) is then forced to flow into the battery core compartment 83, thereby activating the reserve battery unit 80 as shown in the reserve battery unit activated state of FIG. 13. In the activated state of the reserve battery unit 80 shown in FIG. 13, the inertial mass 90 is indicated by the numeral 101 and its “membrane cutters” by the numeral 99. It is appreciated that the cathode 86 and anode 87 are shaped to allow the membrane cutters 99 to clear the two components while breaking through the membrane 85, FIG. 12.

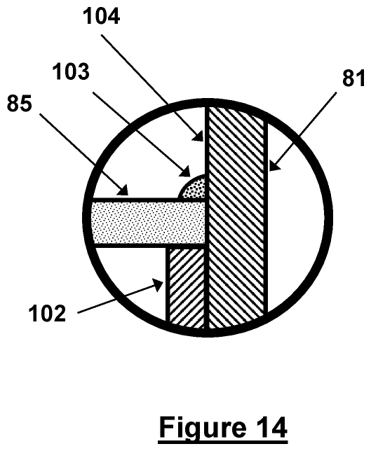

FIG. 14 shows the blow-up view “A” of the cross-sectional view of the reserve battery unit of embodiment of FIG. 12. The blow-up view “A” shows one method of securing the solid membrane 85 to the reserve battery unit side wall 81 and sealing the battery electrolyte in the battery unit compartment 84, FIG. 12. As can be seen in FIG. 14, the solid membrane 85 sits against the “sleeve” 102, which fits inside the battery core compartment 83, FIG. 2. Alternatively, the “sleeve” 102 may be formed as a step integral to the side wall 81. The rigid membrane 85 is then sealed against the interior surface 104 of the side wall 81 by a relatively small bead 103 of a sealant, for example, silicon rubber or the like depending on the type of sealant being used.

In addition, all relatively thin solid membranes are required to be electrically non-conductive. A thin solid membrane may be relatively brittle so that they would readily fracture by the relatively sharp “membrane cutters” (e.g., 97 in FIG. 12), which may be assisted by the provision of stress concentrating grooves or the like on the battery core side of the membranes. Alternatively, a solid membrane may be configured of a readily ruptured material such as a woven and sealed (e.g., with a paraffinic wax layer) fiberglass fabric that is readily punctured by the relatively sharp “membrane cutters” (e.g., 97 in FIG. 12). In the latter case, the “membrane cutters” can be provided with a side “channels” (e.g., may have a “C” shape profile) to assist in the flow of the electrolyte into the battery core.

It is appreciated that like the reserve battery unit embodiment 70 of FIG. 10, the reserve battery unit embodiment 80 of FIG. 12 may also be provided with the added flexible and extensible top sealing layer 105 (71 in FIG. 10), which is used to seal the battery interior from outside environment. The sealing layer 105 is usually a deposited silicon rubber or the like layer.

It is also appreciated that as the liquid electrolyte is pushed into the battery core cavity 83 by the inertial mass 90 downward displacement, the top flexible and extensible layer 105, FIG. 12, would expand to fill most of the vacated volume as shown in FIG. 13 and indicated by the numeral 106.

In the schematic of the reserve battery unit 25 of FIG. 3, the battery unit is shown to have a square or rectangular cross-section (in the direction parallel to the top cover 26). It is, however, appreciated by those skilled in the art that the reserve battery units may have almost any cross-sectional geometry, particularly circular, which may make their manufacture easier. It is also appreciated that the battery units shown in the schematic of FIG. 2 do not have to be all the same size, shape and the same type described in the disclosed embodiments. The battery units may also be distributed over its substrate in any appropriate regular or irregular pattern, for example, they may be arranged around various component of the device in which they are used to maximize space and volume efficiency, particularly in munitions.

It is appreciated by those skilled in the art that the reserve battery unit 25 of FIG. 3 may also be configured and fabricated as a stand-alone reserve battery as compared to its array configuration described for the previous embodiments. It is also appreciated that such stand-alone reserve batteries may have almost any cross-sectional geometries, even non-uniform cross-sections along their height (indicated from the bottom surface, for example, surface 29 in FIG. 4). However, for stand-alone reserve batteries, uniform circular cross-sectional geometries are easier to manufacture and is used in describing such batteries in this disclosure without limiting the embodiment to such a geometry.

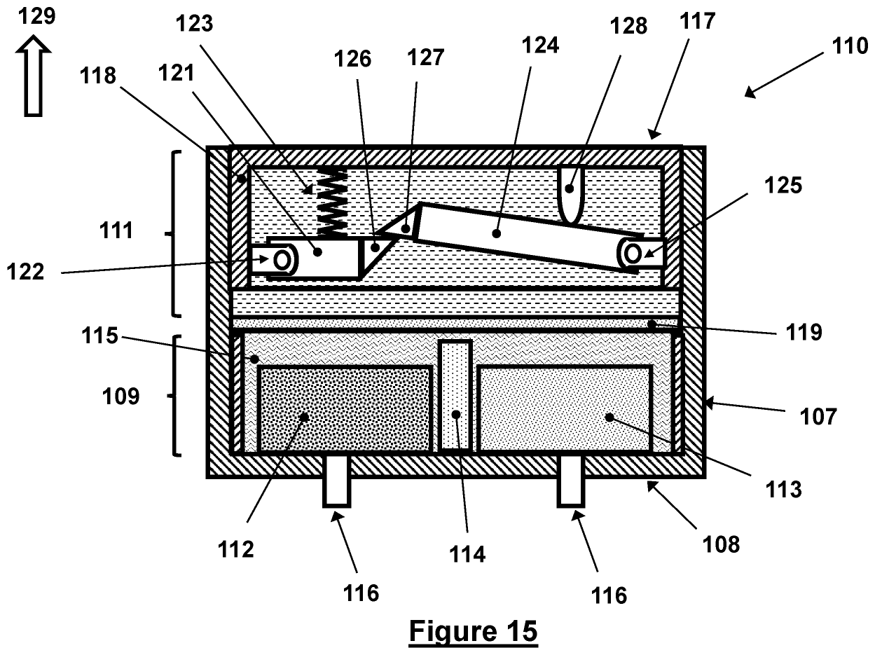

The cross-sectional view of the first stand-alone reserve battery embodiment 110 is shown in the schematic of FIG. 15. The stand-alone reserve battery 110 may have a circular cross-section or any other appropriate cross-section that may be required to accommodate the available space in the device in which it is used to minimize the total occupied space. In the schematic of FIG. 15, the battery housing 107 can be in one piece as shown but may also be constructed by a cylinder side to which the bottom cap 108 is attached, such as by welding or the like. As can be seen in FIG. 15, the inside volume of the reserve battery 110 is divided into a lower compartment 109 and an upper compartment 111 by a relatively solid separator membrane 119. The lower compartment 109 comprises the battery core, within which the cathode 112 and anode 113 components of the battery and their separator 114 are positioned. The void 115 in the cavity 109 can be filled with a wick material to pull the electrolyte into the battery compartment 109 by capillary action upon battery activation as described later.

In the schematic of FIG. 15 the battery terminals 116 (their surrounding electrical insulation layer not shown) are shown to exit from the bottom surface 108 of the battery unit. However, the battery may be configured with terminal exits on the side or top cap of the battery. One of the terminals may also be configured to be the housing body 107 or the top cap surface 117.

The compartment 111 of the stand-alone battery embodiment 110 is used to store the battery electrolyte while the battery is in its pre-activation (reserve) state shown in FIG. 15. The battery top cover 117 is fixedly attached to the battery housing 107, such as by welding or other similar means, particularly when the battery is required to be hermetically sealed. The top cover 117 is part of the member 118, which is used to house the inertial activation mechanism of the battery described later.

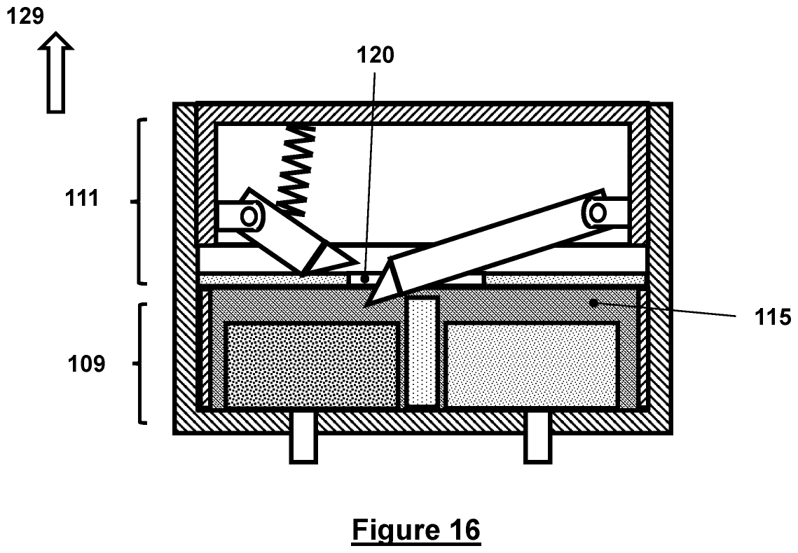

The stand-alone reserve battery embodiment 110 is then activated by partial removal/rupture of the solid membrane 119 barrier and allowing the electrolyte from the compartment 111 to flow into the battery core compartment 109 as later described. In FIG. 16, the reserve battery embodiment 110 is shown in its activated state.

As can be seen in FIG. 15, prior to the battery activation, the electrolyte is stored between the membrane 119 and the battery top cap 117. Then following partial rupture of the membrane 119 as is described later and indicated with the openings 120 in FIG. 16, the liquid electrolyte is released and is pulled into the battery core by the capillary action of the provided wick material in the that compartment 109, FIG. 15, filling the battery core free space 115 around the cathode 112 and anode 113, respectively, as shown in FIG. 16.

It is appreciated by those skilled in the art that the provision of the wick material in the battery core compartment open space 115 and the indicated use of capillary action to pull the liquid electrolyte into the battery core to activate the battery eliminates the need for gravity or other pressurization method to force the electrolyte into the battery core as is the case for the prior art embodiment of FIG. 1.

As it was previously indicated, the top cover 117 of the stand-alone reserve battery embodiment 110 of FIG. 15 is part of the member 118, which is used to house the inertial activation mechanism of the battery described later. It is appreciated by those skilled in the art that many different types of activation mechanisms may be used for this purpose. However, for safety purposes, those types that have the capability of differentiating the prescribed activation acceleration profile, i.e., the minimum acceleration level and duration (all-fire condition in munitions), from all other accidental accelerations (no-fire conditions in munitions) can be used. The activation mechanism shown in the stand-alone reserve battery embodiment 110 of FIG. 15 is such an activation mechanism.

It is also appreciated by those skilled in the art that the type of solid membranes 34 used in the embodiment 30 of FIG. 4, such as those shown in the schematics of FIGS. 6 and 7 may also be used similarly for activation of the disclosed stand-along reserve batteries, such as the stand-alone reserve battery of FIG. 15.

As can be seen in FIG. 15, the battery unit 110 is provided with an inertial activation mechanism, which is mounted inside the member 118. The activation mechanism comprises a release lever 121, which is fixedly attached to the inside surface of the member 118 by a rotary joint 122. The release lever is held in the position shown in FIG. 15 by a preloaded tensile spring 123. The membrane rupturing member of the activation mechanism is the lever 124, which is also fixedly attached to the inside surface of the member 118 by a rotary joint 125. In the pre-activation (reserve) state of the battery embodiment 110 shown in the schematic of FIG. 15, the tip 127 of the lever 124 rests against tip 126 of the release lever 121. In general, the membrane rupturing link 124 is provided with a stop in the joint 125 or a stop 128 to prevent/minimize its clockwise rotation as viewed in FIG. 15 while in its pre-activation state.

Now when the stand-alone reserve battery embodiment 110 is subjected to firing setback acceleration or the like in the direction of the arrow 129 as seen in FIG. 15, the acceleration acts on the centers of mass of the levers 121 and 124, thereby applying a dynamic torsional load to the lever 121 that tends to rotate it in the clockwise direction as viewed in FIG. 15. The preloaded tensile spring 123 would however, tend to counter the applied dynamic torsional load. The spring rate of the preloaded tensile spring 123 and its preloading level are selected such that the applied dynamic torsional load would be prevented from rotating the lever 121 in the clockwise direction enough to disengage and release the lever 124 unless the acceleration in the direction of the arrow 129 has the prescribed minimum magnitude and duration (all-fire condition in munitions) as described below. If the applied acceleration in the direction of the arrow 129 is below the prescribed magnitude and duration (all no-fire conditions in munitions), then even if the lever 121 has rotated slightly (i.e., before disengaging and releasing the lever 124), it would return to its initial position shown in the pre-activation (reserve) state of FIG. 15. The location of the centers of mass of the levers 121 and 124 and their distances from the joints 122 and 125, respectively, and their magnitudes and the spring rate and preloading level of the tensile spring 123 are the parameters that are used to configure the present battery activation mechanisms to achieve the prescribed acceleration profile, i.e., minimum acceleration magnitude and its duration.

Now if the stand-alone reserve battery embodiment 110 of FIG. 15 is subjected to an acceleration in the direction of the arrow 129 that is above the minimum prescribed acceleration and duration (all-fire condition in munitions), then the lever 121 is rotated in the clockwise direction until the tip 127 of the membrane rupturing link 124 disengages the tip 126 of the release lever, thereby freeing the membrane rupturing link 124 to continue to rotate in the counterclockwise direction and rupture the membrane 119 as shown in the post activation state schematic of the battery in FIG. 16. In FIG. 16, the punctured opening in the membrane 119 is shown schematically and indicated by numeral 120. The liquid electrolyte stored in the compartment 111 is then released and is pulled into the battery core by the capillary action of the provided wick material in the compartment 109, FIG. 15, filling the battery core free space 115 around the cathode 112 and anode 113, as shown in FIG. 16, thereby activating the stand-alone reserve battery embodiment 110. It is appreciated that the cathode 112 and anode 113 and the separator 114 are shaped to allow the membrane rupturing link 124 to clear the three components while rupturing (or breaking when more brittle membrane material is used) the membrane 119.

In the stand-alone reserve battery embodiment 110 of FIG. 15, the release lever 121 of the activation mechanism is attached to the member 118 by a rotary joint 122. It is, however, appreciated by those skilled in the art that the release lever may be a relatively flexible member (beam) that is attached to the member 118 by a living joint and is to provide bending resistance for the release of the membrane rupturing link 124 for the battery activation as was described above.

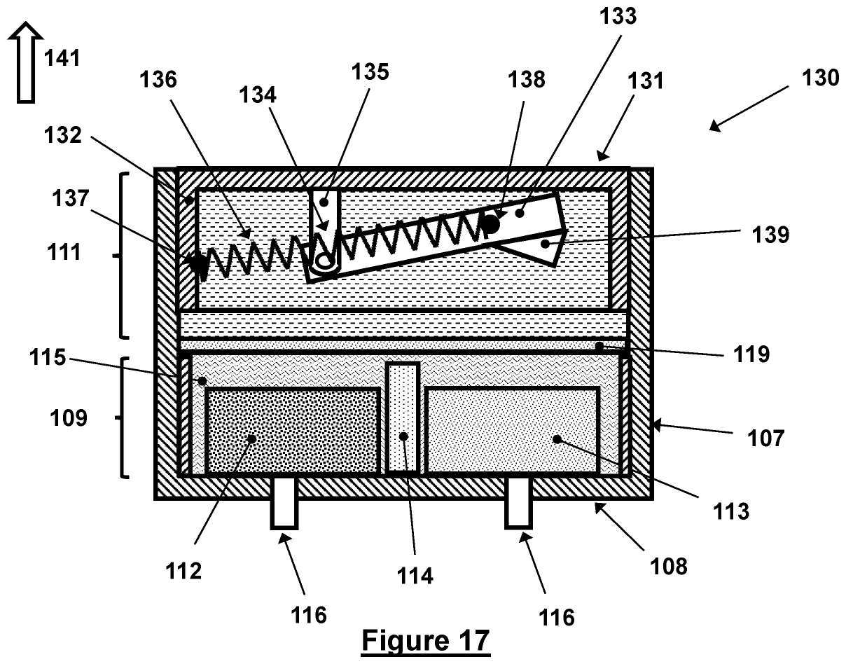

The cross-sectional view of the second stand-alone reserve battery embodiment 130 is shown in the schematic of FIG. 17. The stand-alone reserve battery 130 may have a circular cross-section or any other appropriate cross-section that may be required to accommodate the available space in the device in which it is used to minimize the total occupied space. All components of the stand-alone reserve battery embodiment 130 of FIG. 17 is identical to that of the stand-alone reserve battery embodiment 110 of FIG. 15 and are identically indicated numerally, except for the top cover member 131 (117 in FIG. 15) and its contained inertial activation mechanism.

The compartment 111 of the stand-alone battery embodiment 130 is similarly used to store the battery electrolyte while the battery is in its pre-activation (reserve) state shown in FIG. 17. The battery top cover 131 is fixedly attached to the battery housing 107, such as by welding or other similar means, particularly when the battery is required to be hermetically sealed. The top cover 117 is part of the member 132 (118 in FIG. 15), which is used to house the inertial activation mechanism of the battery described later.

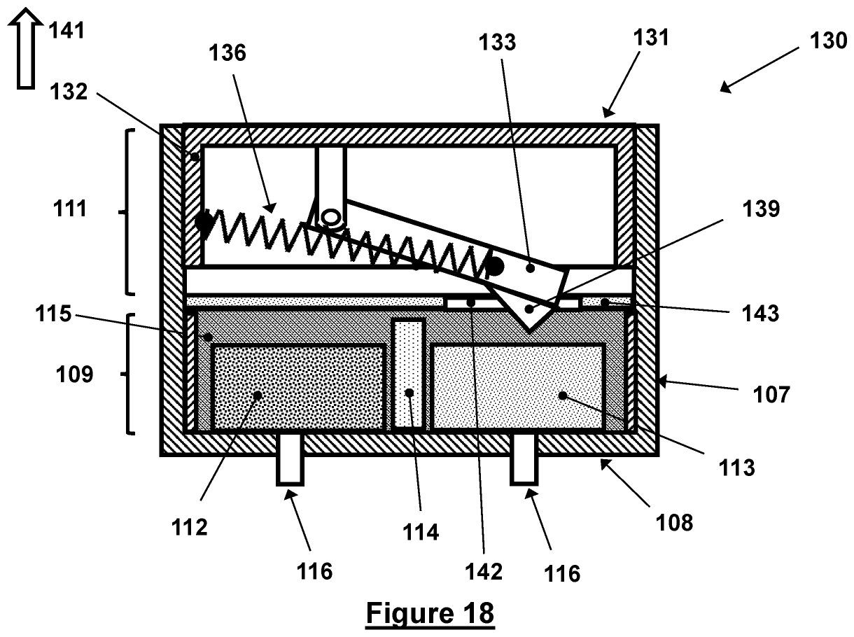

The stand-alone reserve battery embodiment 130 is then activated by partial removal/rupture of the solid membrane 119 barrier and allowing the electrolyte from the compartment 111 to flow into the battery core compartment 109 as later described. In FIG. 18, the stand-alone reserve battery embodiment 130 is shown in its activated state.

As can be seen in FIG. 17, prior to the battery activation, the electrolyte is stored between the membrane 119 and the battery top cap 117. Then following partial rupture of the membrane 119 as is described later and indicated with the openings 142 in FIG. 18, the liquid electrolyte is released and is pulled into the battery core by the capillary action of the provided wick material in the that compartment 109, FIG. 17, filling the battery core free space 115 around the cathode 112 and anode 113, respectively, as shown in FIG. 18.

It is appreciated by those skilled in the art that the provision of the wick material in the battery core compartment open space 115 and the indicated use of capillary action to pull the liquid electrolyte into the battery core to activate the battery eliminates the need for gravity or other pressurization method to force the electrolyte into the battery core as is the case for the prior art embodiment of FIG. 1.

It is appreciated that the above methods of supporting the relatively thin solid membrane 85 of the reserve battery unit embodiment 80 and sealing it to prevent the electrolyte from flowing into the battery core compartment 83 as shown in the blow-up view of FIG. 14 may also be used for the previously described battery unit embodiments, i.e., the embodiments 30, 50 and 70 of FIGS. 4, 8 and 10, respectively, and all stand-alone reserve batteries, such as the embodiments 110 and 130 of FIGS. 15 and 17, respectively.

As it was previously indicated, the top cover 131 of the stand-alone reserve battery embodiment 130 of FIG. 17 is part of the member 132 (118 in FIG. 15), which is used to house the inertial activation mechanism of the battery described later. It is appreciated by those skilled in the art that many different types of activation mechanisms may be used for this purpose. However, for safety purposes, those types that have the capability of differentiating the prescribed activation acceleration profile, i.e., the minimum acceleration level and duration (all-fire condition in munitions), from all other accidental accelerations (no-fire conditions in munitions) can be used. The activation mechanism shown in the stand-alone reserve battery embodiment 130 of FIG. 17 is such an activation mechanism.

It is also appreciated by those skilled in the art that the type of solid membranes 34 used in the embodiment 30 of FIG. 4, such as those shown in the schematics of FIGS. 6 and 7 may also be used similarly for activation of the disclosed stand-along reserve embodiment 130 of FIG. 17.

As can be seen in FIG. 17, the stand-alone reserve battery embodiment 130 is provided with an inertial activation mechanism, which is mounted inside the member 131. The activation mechanism comprises a lever 133, which is fixedly attached to the bottom surface of the member 131 by a rotary joint 134 via the support member 135. The lever 133 is held in the position shown in FIG. 17 by a preloaded tensile spring 136, which is attached on one end 137 to the inner wall of the member 131 and on the other end to the lever 138 as shown in FIG. 17. As can be seen in the pre-activation state of the stand-alone reserve battery embodiment 130 in FIG. 17, the line of action of the preloaded tensile spring 136 is above the rotary joint 134 of the lever 133, thereby biasing it to stay in the configuration shown in FIG. 17 against the bottom surface of the top member 131 or another provided stop (not provided in the schematic of FIG. 17).

It is appreciated by those skilled in the art that the inertial activation mechanism of the stand-alone reserve battery embodiment 130 of FIG. 17 is a toggle mechanism, which in the schematic of FIG. 17 is shown in one of its stable configurations.

The membrane rupturing member of the activation mechanism is the lever 133. In the pre-activation (reserve) state of the battery embodiment 130 shown in the schematic of FIG. 17, the cutting (breaking or shattering) member 139 of the lever 133 is at its farthest distance from the solid membrane 119 as shown in the schematic of FIG. 17.

Now when the stand-alone reserve battery embodiment 130 is subjected to firing setback or impact acceleration or the like in the direction of the arrow 141 as seen in FIG. 17, the acceleration acts on the center of mass of the lever 133, thereby applying a dynamic torsional load to the lever 133 that tends to rotate it in the clockwise direction as viewed in FIG. 17. The preloaded tensile spring 136 would however, tend to counter the applied dynamic torsional load. The spring rate of the preloaded tensile spring 136 and its preloading level are selected such that the applied dynamic torsional load would be prevented from rotating the lever 133 in the clockwise direction passed the point at which the line of action of the tensile spring 136 force passes through the axis of rotation of the rotary joint 134, that is at the unstable configuration of the toggle mechanism formed by the lever 133 and the preloaded tensile spring 136, unless the acceleration in the direction of the arrow 141 has the prescribed minimum magnitude and duration (all-fire condition in munitions) as described below.

If the applied acceleration in the direction of the arrow 141 is below the prescribed magnitude and duration (all no-fire conditions in munitions), then even if the lever 133 has rotated slightly (i.e., reaching its unstable configuration), it would return to its initial position shown in the pre-activation (reserve) state configuration of FIG. 17. The location of the center of mass of the lever 133 and its distance from the joint 134, the mass of the lever 133, the spring rate and preloading level of the tensile spring 136 are the parameters that are used to configuration the present toggle mechanism type battery activation mechanism to achieve the prescribed acceleration profile, i.e., minimum acceleration magnitude and its duration.

Now if the stand-alone reserve battery embodiment 130 of FIG. 17 is subjected to an acceleration in the direction of the arrow 141 that is above the minimum prescribed acceleration level and duration (all-fire condition in munitions), then the lever 133 is rotated in the clockwise direction until the toggle mechanism reaches and passes its aforementioned unstable configuration, from which position, the lever 133 is rotationally accelerated further in the clockwise direction under the aforementioned applied dynamic torsional load as well as the torque generated by the preloaded tensile spring 136. The cutting (breaking or shattering) member 139 of lever 133 would then rupture the membrane 119 (143 in FIG. 18) as shown in the post activation state schematic of the battery in FIG. 18.

In FIG. 18, the punctured opening in the membrane 143 (119 in FIG. 17) is shown schematically and indicated by numeral 142. The liquid electrolyte stored in the compartment 111 is then released and is pulled into the battery core by the capillary action of the provided wick material in the compartment 109, FIG. 17, filling the battery core free space 115 around the cathode 112 and anode 113, as shown in FIG. 18, thereby activating the stand-alone reserve battery embodiment 130. It is appreciated that the cathode 112 and anode 113 and the separator 114 are shaped to allow the cutting (breaking or shattering) member 139 of lever 133 rupture the membrane 119 (143 in FIG. 18) while clearing these three components.

In the stand-alone reserve battery embodiment 130 of FIG. 17, the lever 133 of the activation mechanism is attached to the member 132 by a rotary joint 134. It is, however, appreciated by those skilled in the art that the lever 133 may alternatively be attached to the member 132 by a living joint to simplify the construction of the activation mechanism and its assembly, particularly for relatively small reserve batteries.

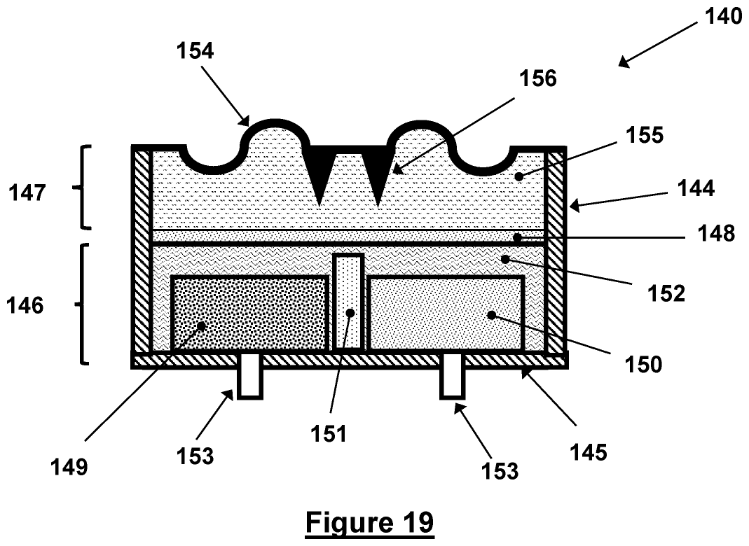

The cross-sectional view of the first manually activated stand-alone reserve battery embodiment 140 is shown in the schematic of FIG. 19. The stand-alone reserve battery 140 may have a circular cross-section or any other appropriate cross-section that may be required to accommodate the available space in the device in which it is used to minimize the total occupied space. In the schematic of FIG. 19, the battery housing 144 can be in one piece as shown but may also be constructed by a cylinder side to which the bottom cap 145 is attached, such as by welding or the like. As can be seen in FIG. 19, the inside volume of the manually activated stand-alone reserve battery 140 is divided into a lower compartment 146 and an upper compartment 147 by a relatively solid separator membrane 148. The lower compartment 146 constitutes the battery core, within which the cathode 149 and anode 150 components of the battery and their separator 151 are positioned. The void 115 in the cavity 146 can be filled with a wick material (not shown) to pull the electrolyte into the battery compartment 146 by capillary action upon battery activation as described later.

In the schematic of FIG. 19 the battery terminals 153 (their surrounding electrical insulation layer not shown) are shown to exit from the bottom surface 145 of the battery unit. However, the battery may be configured with terminal exits on the side or top cap of the battery. One of the terminals may also be configured to be the housing body 144.

The compartment 147 of the stand-alone battery embodiment 140 is used to store the battery electrolyte while the battery is in its pre-activation (reserve) state shown in FIG. 19. The battery top cover 154, which can be made with the same material as the battery housing 144 and is fabricated as a diaphragm to make it flexible in the axial direction (up and down as seen in the view of FIG. 19), is fixedly attached to the battery housing 144, such as by welding or other similar means, particularly when the battery is required to be hermetically sealed. Such metal diaphragms are well known in the art and are used widely in pressure sensors, diaphragm pumps, and the like.

The stand-alone reserve battery embodiment 140 is then activated by partial removal/rupture of the solid membrane 148 barrier and allowing the electrolyte in the space 155 from the compartment 147 to flow into the battery core compartment 146 as later described. In FIG. 120, the reserve battery embodiment 140 is shown in its activated state.

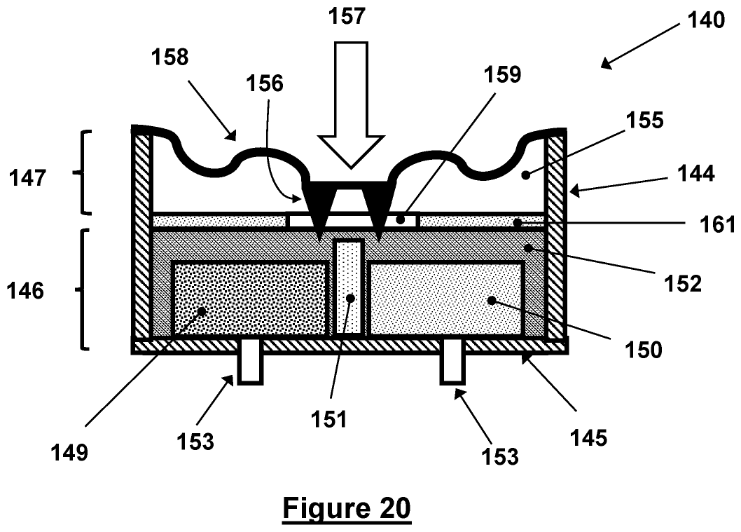

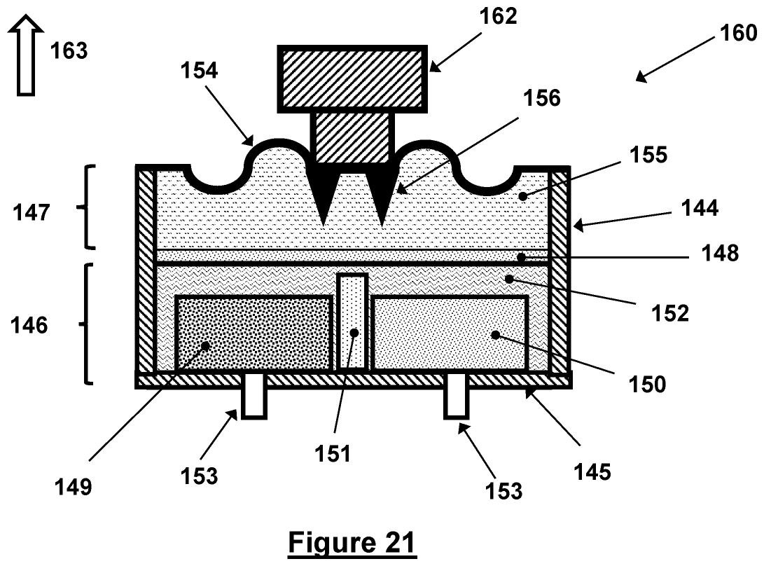

As can be seen in FIG. 19, prior to the battery activation, the electrolyte in the space 155 is stored between the membrane 148 and the battery top cap 154. Then following partial rupture of the membrane 148 as is described later and indicated with the openings 159 in FIG. 20, the liquid electrolyte is released and is pulled into the battery core by the capillary action of the provided wick material in the that compartment 146, FIG. 19, filling the battery core free space 152 around the cathode 149 and anode 150 as shown in FIG. 20.

It is appreciated by those skilled in the art that the provision of the wick material in the battery core compartment open space 152 and the indicated use of capillary action to pull the liquid electrolyte into the battery core to activate the battery eliminates the need for gravity or other pressurization method to force the electrolyte into the battery core as is the case for the prior art embodiment of FIG. 1.

As can be seen in the schematic of FIG. 19, the battery top diaphragm cap 154 is provided with cutting (breaking or shattering) members 156, which are fixedly attached to the battery side surface of the cap 154. In the pre-activation (reserve) state of the battery embodiment 140 shown in the schematic of FIG. 19, the membrane 148 cutting members 156 are positioned slightly above the surface of the membrane 148.

The stand-alone reserve battery embodiment 140 of FIG. 19 is configured to be manually activated. Now if the battery top diaphragm cap 154 (158 in FIG. 20) is pressed down manually (or by certain electrical or pneumatic or the like actuator known in the art) in the direction of the arrow 157, then the central region of the battery top diaphragm cap 154 would displace in the direction of the arrow 157, causing the diaphragm cap 154 to deform to the configuration 158 shown in FIG. 20, thereby causing the cutting (breaking or shattering) members 156 to create an opening 159 in the membrane 161 (148 in FIG. 19). The liquid electrolyte stored in the space 155 of the compartment 147 is then released and is pulled into the battery core by the capillary action of the provided wick material in the compartment 146, FIG. 20, filling the battery core free space 152 around the cathode 149 and anode 150, as shown in FIG. 20, thereby activating the stand-alone reserve battery embodiment 140. It is appreciated that the cathode 149 and anode 150 and the separator 151 are shaped to allow the membrane cutting member 156 clear the three components while rupturing (or breaking when more brittle membrane material is used) the membrane 148 (161 in FIG. 20).

The stand-alone reserve battery embodiment 140 of FIG. 19 was shown to be configured to be activated manually (or by the use of an electrical, pneumatic or the like linear actuator or the like known in the art). It is, however, appreciated by those skilled in the art that this reserve battery configuration can be readily modified to become capable of being activated inertially when subjected to a prescribed acceleration, for example firing setback or impact acceleration in munitions. This modified version of the stand-alone reserve battery embodiment 140 of FIG. 19 is shown schematically in FIG. 21 and is indicated as the stand-alone reserve battery embodiment 160.

The cross-sectional view of the modified stand-alone reserve battery embodiment 140 of FIG. 19 is shown in the schematic of FIG. 21 and indicated as the embodiment 160. All components of the modified stand-alone reserve battery embodiment 160 are identical to that of the embodiment 140 of FIG. 19 except for the addition of the mass member 162, which is fixedly attached to the battery diaphragm top cap 154, such as by welding or brazing or the like, as shown in FIG. 21. In the schematic of FIG. 21, the modified stand-alone reserve battery embodiment 160 is shown in its pre-activation state.

In the modified stand-alone reserve battery embodiment 160, the effective inertia of the provided mass member 162 and the battery diaphragm top cap 154 would determine the dynamic force that acts downward on the battery diaphragm top cap 154, as viewed in FIG. 21, as the battery is accelerated in the direction of the arrow 163. In addition, the effective spring rate of the battery diaphragm top cap 154 in response to a force applied in the direction of the arrow 157, FIG. 20, determines the amount of downward displacement of the mass member 162, noting that said spring rate of the diaphragm top cap 154 is not linear and would generally increase with increased deflection.

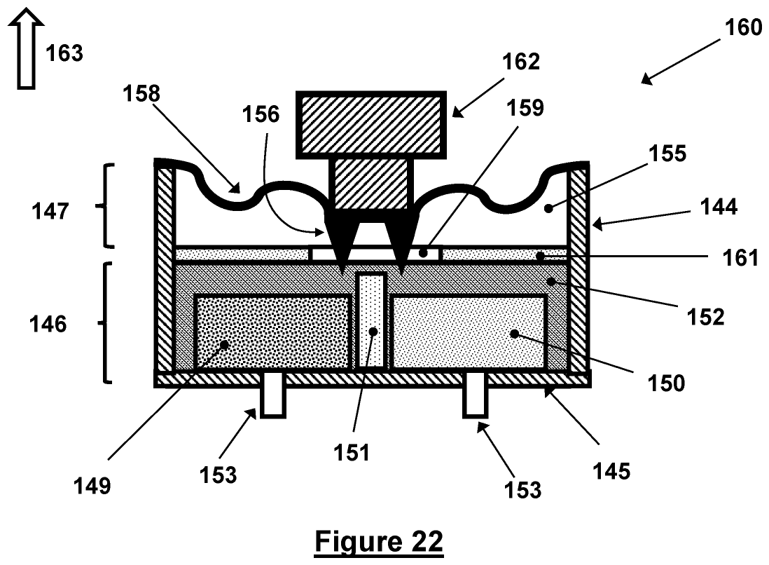

The mass of the mass member 162 and the spring rate of the battery diaphragm top cap 154 are selected such that the mass member 162 is prevented from displacing down enough for the cutting members 156 to rupture (break or shatter) the membrane 148, FIG. 21, unless the stand-alone reserve battery 160 is subjected to a high enough acceleration level and for long enough duration in the direction of the arrow 163 (e.g., corresponding to the munition all-fire condition using the reserve battery). Once the mass member 162 and thereby the cutting members 156 have displaced down enough for the cutting member to create the opening 159 in the membrane 148 (membrane with the opening 159 is indicated by the numeral 161 in FIG. 22), the electrolyte stored in the compartment 147 of the battery is free to flow into the battery core compartment 146.

Now when the reserve modified stand-alone reserve battery embodiment 160 is subjected to the previously described firing setback or impact acceleration profile, i.e., minimum acceleration level and duration, in the direction of the arrow 163, FIG. 21, the inertial force acting on the effective inertial of the mass member 162 and the top cap diaphragm 154 is configured to displace the cutting members 156 downwards enough to engage and cut (break or shatter) the membrane 148 and create the opening 159 in the membrane (161 with the opening 159 in FIG. 22). Otherwise, if the acceleration in the direction of the arrow 163 ceases before the cutting member 156 would engage the membrane 148, FIG. 21, then the top cap diaphragm 154 would return the mass member to its pre-activation state. This could, for example, happen due to accidental drop of the device in which the reserve battery unit 160 is positioned or due to transportation vibration or other accidental events due to which the reserve battery 160 is not to activate (no-fire conditions in munitions).

Now, when the modified stand-alone reserve battery embodiment 160 is subjected to the aforementioned prescribed high enough magnitude and long enough duration (e.g., all-fire condition in munitions), then once the opening 159 is created in the membrane 161, FIG. 22, the electrolyte stored in the space 155 of the compartment 147 would flow into the battery core compartment 146, thereby activating the reserve battery as shown in FIG. 22. The electrolyte flow into the battery core compartment 146 is assisted by the wick material filling usually provided in the space around the cathode, anode, and the separator by capillary action.

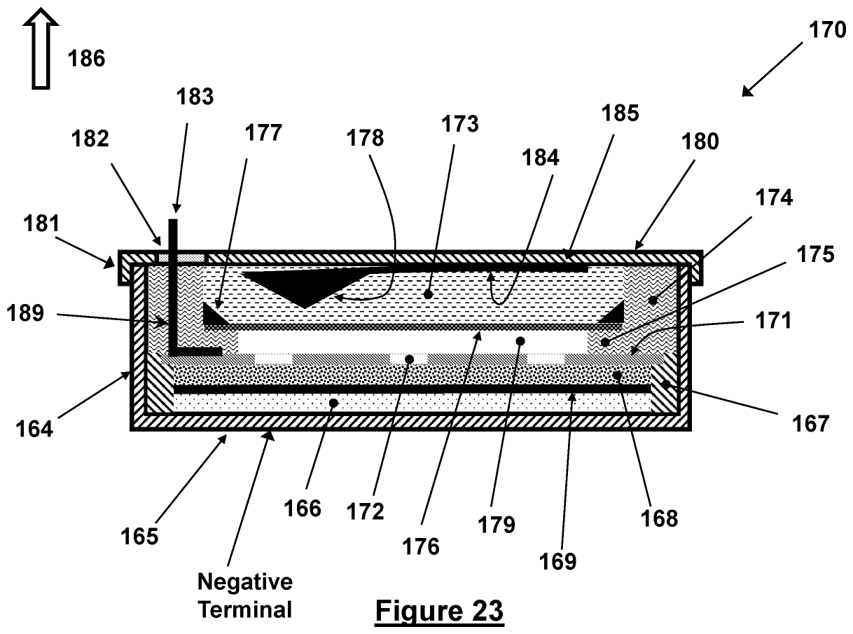

The cross-sectional view of another stand-alone reserve battery embodiment 170 is shown in the schematic of FIG. 23. The stand-alone reserve battery 170 may have a circular cross-section or any other appropriate cross-section that may be required to accommodate the available space in the device in which it is used to minimize the total occupied space. In the schematic of FIG. 23, the battery housing 164 such as in one piece as shown but may also be constructed by a cylinder side to which the bottom cap 165 is attached, such as by welding or the like. The battery anode 166 is positioned against the inner surface of the bottom cap 165, thereby making the battery housing 164, including its bottom cap 165 as the negative terminal of the battery. The cathode 168 is positioned over the anode 166 and separated from it by the separator 169. Both anode 166 and cathode 168 are separated from the inside wall surface of the housing 164 by the electrical insulating layer 167, for example one made from Teflon.

A metal (for example made from copper) charge collector 171 is positioned firmly against the cathode 168 inside the insulating layer 167 to prevent it from contact with the surface of the housing 164. The charge collector 171 is provided with series of openings 172 to allow the battery electrolyte stored in the compartment 173 to flow into cathode 168 side of the battery core upon battery activation.

The charge collector 171 is held firmly against the cathode 168 by the electrically non-conductive member 174, which is provided with a step section 175, which is used to hold the charge collector 171 firmly against the cathode 168 as well as to accommodate the relatively rigid membrane 176, which is, for example, made of a relatively thin ceramic material such as alumina, so that it can be readily broken (shattered) as described later to activate the battery. The relatively rigid membrane 176 is sealed against the side of the non-conductive member 174, for example by a “bead” 177 of silicon rubber or the like as shown in FIG. 23.

The void space 179 between the membrane 176 and the charge collector 168 can be filled with a wick material (not shown) to pull the electrolyte into the void space by capillary action upon battery activation as described later.

The battery housing 164 is capped by the cap member 180, such as by welding or the like, particularly when the battery must be hermetically sealed. The cap member 180 may be formed at its periphery by a lip 181 or the housing wall may be provided with a step (not shown) or the like to facilitate the welding of the cap member 180 to the battery housing 164. The cap member 180 is also provided with an opening 182 through which the positive terminal 183 of the battery exits. The opening 182 in the cap member 180 is filled and sealed by an electrically non-conductive material, such as glass, through which the terminal wire 183 is shown to pass. The terminal wire 183 extends through the electrically non-conductive member 174, and is attached to the charge collector 171, such as by soldering or the like with good electrical conductivity. The terminal wire 183 is connected to the charge collector 168 by the conductive wire 189, such as by soldering.

The compartment 173 within which the battery electrolyte is stored in the pre-activation state of the stand-alone reserve battery embodiment 170 is formed between the relatively rigid membrane 176 and the cap member 180 with the sides of the electrically non-conductive member 174. The previously described sealing 177 and sealing provided between the cap member 180 and the electrically non-conductive member 174 (not shown for the sake of clarity) ensures that the liquid electrolyte stays within the compartment 173.

The stand-alone reserve battery embodiment 170 is provided with an inertial activation mechanism. The inertial activation mechanism in this battery is shown to comprise a relatively flexible beam element 184, which is fixedly attached to the inner surface of the cap member 180, such as by welding or brazing or the like. The beam element 184 is flexible with a selected stiffness in the bending direction of its free end to which a relatively sharp cutting (breaking or shattering) member 178 is fixedly attached. In the pre-activation state of the battery, the flexible beam 184 is preloaded to be biased against the inner surface of the cap member 180 to provide the capability of achieving prescribed battery activation when a prescribed acceleration in the direction of the arrow 186 is detected as described later.

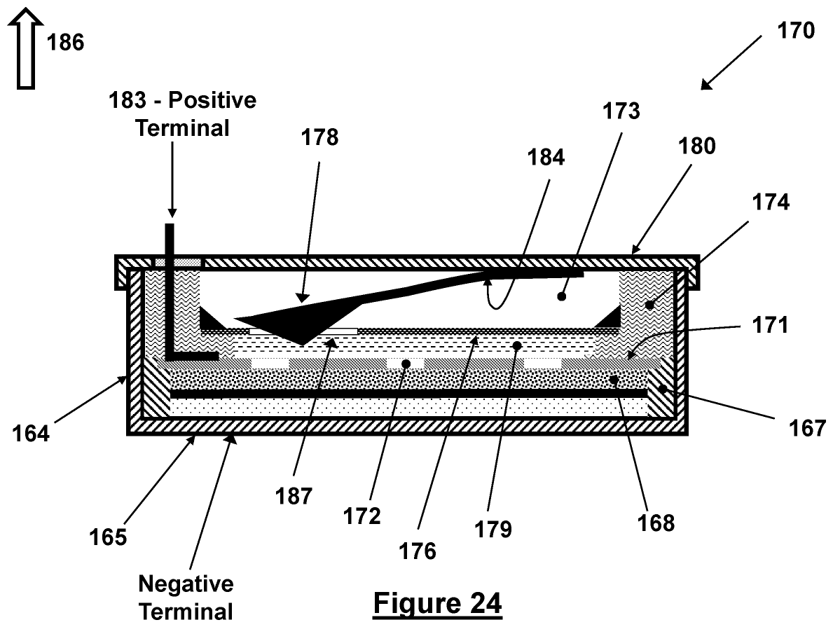

The stand-alone reserve battery embodiment 170 is then activated by partial removal/rupture of the solid membrane 176 barrier and allowing the electrolyte from the compartment 173 to flow into the void space 179, assisted with the capillary action of the filling wick material, and through the space 179 to diffuse into the cathode 168 through the openings 172 provided in the charge collector 171, thereby activating the battery. In FIG. 24, the reserve battery embodiment 170 is shown in its activated state.

It is appreciated by those skilled in the art that the provision of the wick material in the void space 179 and the indicated use of capillary action to pull the liquid electrolyte into space 179 to activate the battery eliminates the need for gravity or other pressurization method to force the electrolyte into the battery core as is the case for the prior art embodiment of FIG. 1. It is appreciated by those skilled in the art that many different types of activation mechanisms may be used in place of the mechanism comprising the flexible beam 184 and the cutting member 178. However, for safety purposes, those types that have the capability of differentiating the prescribed activation acceleration profile, i.e., the minimum acceleration level and duration (all-fire condition in munitions), from all other accidental accelerations (no-fire conditions in munitions) can be used. The activation mechanism shown in the stand-alone reserve battery embodiment 170 of FIG. 23 is such an activation mechanism.

It is also appreciated by those skilled in the art that the type of solid membranes 34 used in the embodiment 30 of FIG. 4, such as those shown in the schematics of FIGS. 6 and 7 may also be used similarly for activation of the disclosed stand-along reserve batteries, such as the stand-alone reserve battery embodiment 170 of FIG. 23.

Now when the stand-alone reserve battery embodiment 170 is subjected to firing setback acceleration or the like in the direction of the arrow 186 as seen in FIG. 23, the acceleration acts on the centers of mass of the flexible beam 184 and cutting member 178 assembly, thereby applying a dynamic bending moment to the flexible beam 184 that tends to displace the cutting member downward as viewed in FIG. 23. The preloaded flexible beam 184 would however, tend to counter the applied dynamic bending moment. The bending flexibility of the preloaded flexible beam 184 and its preloading level are selected such that the applied dynamic bending moment would be prevented from deflecting the cutting member 178 enough to engage and rupture (break or shatter) the membrane 176 unless the acceleration in the direction of the arrow 186 has the prescribed minimum magnitude and duration (all-fire condition in munitions). If the applied acceleration in the direction of the arrow 186 is below the prescribed magnitude and duration (all no-fire conditions in munitions), then the dynamic bending moment would either not be large enough to overcome the beam preload and/or enough time to displace the cutting member 178 down enough to engage the membrane 176. As a result, the flexible beam 184 and cutting member 178 assembly would return to its initial position shown in the pre-activation (reserve) state of FIG. 23. The location of the effective center of mass of the flexible beam 184 and cutting member 178 assembly and its distance from the fixed end 185 and its magnitude and the flexural bending rate and preloading level of the flexible beam 184 are the parameters that are used to configuration the present battery activation mechanisms to achieve the prescribed acceleration profile, i.e., minimum acceleration magnitude and its duration.

Now if the stand-alone reserve battery embodiment 170 of FIG. 23 is subjected to an acceleration in the direction of the arrow 186 that is above the minimum prescribed acceleration and duration (all-fire condition in munitions), then the cutting member 178 is displaced down as viewed in FIG. 23 and would engage and rupture (break or shatter) the electrically non-conductive membrane 176 as shown in the post activation state schematic of the battery in FIG. 24. In FIG. 24, the punctured opening in the membrane 176 is shown schematically and indicated by numeral 187. The liquid electrolyte stored in the compartment 173 is then released and is pulled into the space 179 by mostly the capillary action of the provided wick material, filling the space 179 and diffusing into the cathode 168 through the openings 172 in the charge collector 171, thereby activating the stand-alone reserve battery embodiment 170.

A stop limiting downward displacement of the cutting member 178 (not shown for the sake of clarity) can be provided to ensure that the cutting member 178 does not come into contact with the charge collector 168.

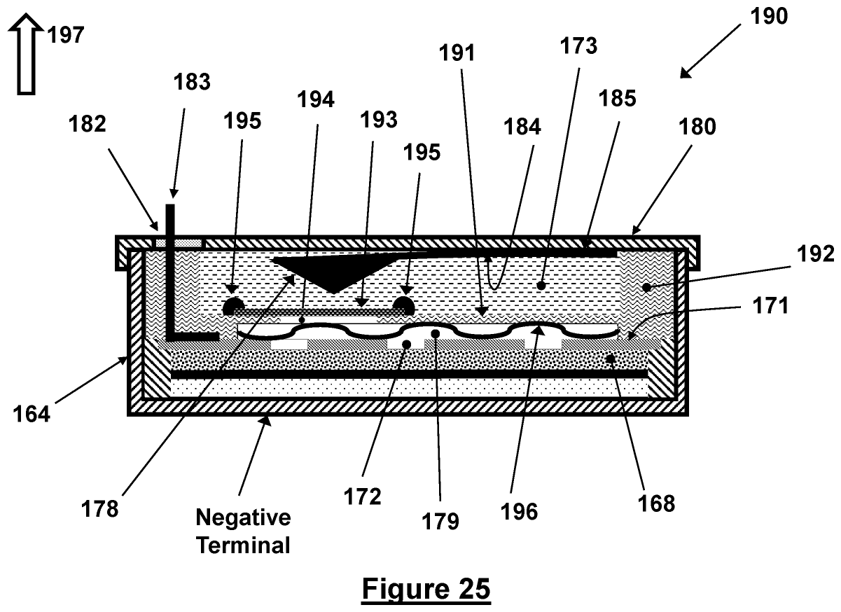

It is appreciated by those skilled in the art that in stand-alone reserve batteries such as the embodiment 170 of FIG. 23, the charge collector 168 can be pressed against the cathode 168 for efficient operation of the battery upon activation. This can, for example, be achieved by modifying the embodiment 170 and providing preloaded compressive springs between the electrically non-conductive member 174 and the charge collector as shown in the cross-sectional schematic of FIG. 25 and indicated by the numeral 190.

The stand-alone reserve battery embodiment 190 of FIG. 25 has all its components identical to that of the embodiment 170 of FIG. 23, except for the components modifications to allow for the provision of preloaded spring used to pressure the charge collector 171 against the cathode 168 as described below.

As can be seen in the schematic of FIG. 25, the step section 191 (175 in FIG. 23) of the electrically non-conductive member 192 (174 in FIG. 23) is extended to cover a larger surface area of the charge collector 168. The opening 194 in the step section 191 is then covered by the relatively rigid membrane 193 (176 in FIG. 23), which is held and sealed to the section 191 by seal 195 to prevent the electrolyte to flow from the compartment 173 into the space 179 between the section 191 and the charge collector 171. A compressively preloaded wave spring 196 is then positioned between the section 191 and the charge collector 171 to apply a constant pressure to the charge collector and thereby keep the charge collector 171 pressed against the cathode 168.

Then when the stand-alone reserve battery embodiment 190 of FIG. 25 is subjected to acceleration in the direction of the arrow 197 and the acceleration has the prescribed minimum magnitude and duration, then the cutting member 178 displace down as viewed in FIG. 25 due to the bending deflection of the flexible beam 184 as was previously described for the embodiment 170 of FIG. 23, and ruptures (breaks or shatter) the membrane 193, allowing the electrolyte to flow through the created opening 194 into the space 179, such as assisted by the capillary action of the wick material in the space 179. The electrolyte will then diffuse into the cathode 168 and activate the battery as was described for the embodiment 170 of FIG. 23.

It is appreciated by those skilled in the art that the no stored mechanical energy is provided to the above stand-alone inertially activated reserve battery embodiments, i.e., embodiment of FIGS. 8, 10, 12, 15, 17, 21, 23 and 24. In many applications, including in many munition applications, particularly when the firing setback or impact induced activation acceleration is relatively high and has relatively long duration (at least in the order of 4-10 milliseconds), such stand-alone inertially activated reserve battery embodiments can be used. However, when the firing setback or impact induced activation acceleration level is low (usually below 200-300 G) and/or its duration is short (in the order of 1-4 milliseconds), then stored mechanical energy in the form of preloaded tensile or compressive springs, which are then released by the firing setback or impact induced activation acceleration, can be used to achieve battery activation.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. A reserve battery comprising:
a housing having first and second compartments separated by a membrane,
the first compartment having an anode and cathode and a separator positioned between the anode and cathode;
the second compartment having an electrolyte for use with the anode and cathode to produce electrical power, the electrolyte being sealed in the second compartment relative to the first compartment at least by the membrane;
electrodes connected to the anode and cathode each having a portion on an outside of the housing;
wherein the second compartment having cavity in which a wick material is arranged, the wick material being configured to pull the electrolyte into the second compartment from the first compartment by capillary action when the membrane changes from a sealed state in which the electrolyte is sealed within the second compartment to an unsealed state in which the electrolyte can flow into the first compartment.

2. The reserve battery of claim 1, wherein the housing having a top cover corresponding to the second compartment, the top cover being formed of an extensible material such that when the membrane is in the unsealed state, the top cover deforms to reduce the volume in the second compartment.

3. The reserve battery of claim 1, wherein at least a portion of the membrane is formed of wax and the membrane includes a heating wire such that when the heating wire is heated, the membrane takes on the unsealed state.

4. The reserve battery of claim 1, further comprising an inertial mass forming a portion of the second compartment, the inertial mass being movable in a direction opposing an acceleration direction, the inertial mass at least indirectly having one or more projections configured to engage with and break the membrane when the housing experiences an acceleration greater than a predetermined acceleration.

5. The reserve battery of claim 4, further comprising a seal for sealing the inertial mass relative to the housing and the first compartment.

6. The reserve battery of claim 4, further comprising an activation device configured to change the state of the membrane to the unsealed state upon the predetermined acceleration comprising an all-fire acceleration.

7. The reserve battery of claim 1, wherein the housing having a cover forming a part of the second compartment, the cover having one or more projections, the cover being movable such that when pressed manually in an axial direction towards the first compartment, the one or more projections pierce the membrane such that the membrane takes on the unsealed state.

8. The reserve battery of claim 1, wherein the anode and cathode are spaced apart in one of a radial direction or in an axial direction of the housing.

9. The reserve battery of claim 1, wherein the membrane takes on the unsealed state by being broken.

10. A reserve battery comprising:
a substrate having a plurality of openings defining a cavity; and
a reserve battery provided in each of the plurality of openings, each of the reserve batteries comprising:
an anode and a cathode disposed in a first portion of each of the plurality of openings;
a separator positioned between the anode and cathode disposed in each of the plurality of openings;
an electrolyte disposed in a second portion of each of the plurality of openings, the electrolyte being for use with the anode and cathode to produce electrical power, the electrolyte being sealed in the second portion relative to the first portion at least by a membrane separating the first and second portions;
electrodes connected to the anode and cathode, each having a portion on an outside of the substrate;
wherein the second portion having a wick material, the wick material being configured to pull the electrolyte into the second portion from the first portion by capillary action when the membrane changes from a sealed state in which the electrolyte is sealed within the second portion to an unsealed state in which the electrolyte can flow into the first portion.

11. The reserve battery of claim 10, wherein each reserve battery having a top cover corresponding to the second portion, the top cover being formed of an extensible material such that when the membrane is in the unsealed state, the top cover deforms to reduce the volume in the second portion.

12. The reserve battery of claim 10, wherein at least a portion of the membrane is formed of wax and the membrane includes a heating wire such that when the heating wire is heated, the membrane takes on the unsealed state.

13. The reserve battery of claim 10, wherein each reserve battery further comprising an inertial mass forming a portion of the second portion, the inertial mass being movable in a direction opposing an acceleration direction, the inertial mass at least indirectly having one or more projections configured to engage with and break the membrane when the housing experiences an acceleration greater than a predetermined acceleration.

14. The reserve battery of claim 13, wherein each reserve battery further comprising a seal for sealing the inertial mass relative to the housing and the first portion.

15. The reserve battery of claim 13, wherein each reserve battery further comprising an activation device configured to change the state of the membrane to the unsealed state upon the predetermined acceleration comprising an all-fire acceleration.

16. The reserve battery of claim 10, wherein each reserve battery having a cover forming a part of the second portion, the cover having one or more projections, the cover being movable such that when pressed manually in an axial direction towards the first compartment, the one or more projections pierce the membrane such that the membrane takes on the unsealed state.

17. The reserve battery of claim 10, wherein the anode and cathode are spaced apart in one of a radial direction or in an axial direction of the housing.

18. The reserve battery of claim 10, wherein the membrane takes on the unsealed state by being one of broken.

19. A munition comprising:
a reserve battery comprising:
a housing having first and second compartments separated by a membrane,
the first compartment having an anode and cathode and a separator positioned between the anode and cathode;
the second compartment having an electrolyte for use with the anode and cathode to produce electrical power, the electrolyte being sealed in the second compartment relative to the first compartment at least by the membrane;
electrodes connected to the anode and cathode each having a portion on an outside of the housing;
wherein the second compartment having cavity in which a wick material is arranged, the wick material being configured to pull the electrolyte into the second compartment from the first compartment by capillary action when the membrane changes from a sealed state in which the electrolyte is sealed within the second compartment to an unsealed state in which the electrolyte can flow into the first compartment.

20. The munition of claim 19, wherein the reserve battery further comprising:
an inertial mass forming a portion of the second compartment, the inertial mass being movable in a direction opposing an acceleration direction, the inertial mass at least indirectly having one or more projections configured to engage with and break the membrane when the housing experiences an acceleration greater than an all-fire acceleration; and
an activation device configured to change the state of the membrane to the unsealed state upon the housing experiencing the all-fire acceleration.
